(19) United States
(12) Patent Application Publication
(10) Pub. No.: US 2026/0133434 A1
(43) Pub. Date: May 14, 2026

(54) POLYCHROMATIC ILLUMINATION IN HOLOGRAPHIC DISPLAYS

(71) Applicant: Meta Platforms Technologies, LLC, Menlo Park, CA (US)

(72) Inventors: Oliver Strider Cossairt, Seattle, WA (US); Grace Elizabeth Kuo, Seattle, WA (US); Douglas Robert Lanman, Bellevue, WA (US); Nathan Matsuda, Seattle, WA (US)

(21) Appl. No.: 19/387,519

(22) Filed: Nov. 12, 2025

Related U.S. Application Data
(60) Provisional application No. 63/720,125, filed on Nov. 13, 2024.

(51) Int. Cl. G02B 27/48; G02B 27/01

(52) U.S. Cl. CPC G02B 27/48; G02B 27/0172; G02B 2027/0118; G02B 2027/0174

(57) ABSTRACT

An apparatus for reducing speckle in holographic displays is disclosed. An illumination subsystem with one or more emitters and wavelength-selection elements provides multiple mutually incoherent spectral components at discrete wavelengths. A modulation stage receives the illumination, and display optics direct modulated light toward an image plane. Control circuitry selects at least two discrete wavelengths, computes wavelength-aware modulation patterns to decorrelate wavelength-dependent speckle fields, and directs the illumination subsystem to illuminate the modulation stage with the selected wavelengths effectively concurrently within an integration interval while applying the computed patterns. Resulting intensities from the concurrently illuminated, mutually incoherent wavelengths incoherently sum at the image plane to reduce speckle. The architecture can be integrated into near-eye display systems. Methods of use and manufacture are also disclosed.

### CROSS REFERENCE TO RELATED APPLICATION

This application claims priority to U.S. Application No. 63,720,125, filed 13 Nov. 2024, the disclosure of which is incorporated, in its entirety, by this reference.

### SUMMARY

In some aspects, the techniques described herein relate to a holographic display apparatus including: an illumination subsystem having one or more emitters and wavelength-selection elements configured to provide a plurality of mutually incoherent spectral components at discrete wavelengths; a modulation stage positioned to receive light from the illumination subsystem; display optics arranged to direct modulated light from the modulation stage toward an image plane; and control circuitry configured to: select at least two of the discrete wavelengths and to compute modulation patterns for the modulation stage that decorrelate wavelength-dependent speckle fields at an image plane, and direct the illumination subsystem to illuminate the modulation stage with the selected wavelengths effectively concurrently within an integration interval and to apply the computed modulation patterns such that intensities from the concurrently illuminated, mutually incoherent wavelengths incoherently sum at the image plane in a manner that reduces speckle.

In some aspects, the techniques described herein relate to a method of reducing speckle in a holographic display, the method including: emitting, from an illumination subsystem including one or more emitters and wavelength-selection elements, a plurality of mutually incoherent spectral components at discrete wavelengths; selecting at least two of the discrete wavelengths; computing, for the selected wavelengths, modulation patterns configured to decorrelate wavelength-dependent speckle fields at an image plane; concurrently illuminating a modulation stage with the selected wavelengths while applying the computed modulation patterns to the modulation stage; and displaying modulated light from the modulation stage such that intensities produced by the concurrently illuminated, mutually incoherent wavelengths incoherently sum at the image plane to reduce speckle.

In some aspects, the techniques described herein relate to a method of manufacturing a holographic display apparatus, the method including: providing an illumination subsystem having configured to provide a plurality of mutually incoherent spectral components at discrete wavelengths; positioning a modulation stage to receive light from the illumination subsystem; arranging display optics to direct modulated light from the modulation stage toward an image plane; and programming control circuitry to: select at least two of the discrete wavelengths, compute modulation patterns for the modulation stage configured to decorrelate wavelength-dependent speckle fields at the image plane, and direct the illumination subsystem to illuminate the modulation stage with the selected wavelengths effectively concurrently within an integration interval while applying the computed modulation patterns such that intensities from the concurrently illuminated, mutually incoherent wavelengths incoherently sum at the image plane to reduce speckle.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an example calibration system according to embodiments of this disclosure.

FIG. 2 is an illustration of calibration data visualization according to embodiments of this disclosure.

FIG. 3 is a block diagram of a system for polychromatic illumination in holographic displays according to embodiments of this disclosure.

FIG. 4 is a flow diagram of a method for polychromatic illumination in holographic displays according to embodiments of this disclosure.

FIG. 5 is a block diagram of a method for manufacturing a system for polychromatic illumination in holographic displays according to embodiments of this disclosure.

FIG. 6 is an illustration of an example artificial-reality system according to some embodiments of this disclosure.

FIG. 7 is an illustration of an example artificial-reality system with a handheld device according to some embodiments of this disclosure.

FIG. 8A is an illustration of example user interactions within an artificial-reality system according to some embodiments of this disclosure.

FIG. 8B is an illustration of example user interactions within an artificial-reality system according to some embodiments of this disclosure.

FIG. 9A is an illustration of example user interactions within an artificial-reality system according to some embodiments of this disclosure.

FIG. 9B is an illustration of example user interactions within an artificial-reality system according to some embodiments of this disclosure.

FIG. 10 is an illustration of an example wrist-wearable device of an artificial-reality system according to some embodiments of this disclosure.

FIG. 11 is an illustration of an example wearable artificial-reality system according to some embodiments of this disclosure.

FIG. 12 is an illustration of an example augmented-reality system according to some embodiments of this disclosure.

FIG. 13A is an illustration of an example virtual-reality system according to some embodiments of this disclosure.

FIG. 13B is an illustration of another perspective of the virtual-reality systems shown in FIG. 13A.

FIG. 14 is a block diagram showing system components of example artificial- and virtual-reality systems.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Devices, apparatuses, systems, and methods that support techniques for polychromatic illumination for speckle control in holographic displays are disclosed. In some examples, speckle noise may be a persistent issue in holographic displays, arising from the interference of coherent light sources. This noise may manifest as granular distortions in the displayed images, compromising visual quality and reducing the effectiveness of depth cues. Existing speckle reduction techniques, such as time-multiplexing and partial spatial coherence, may have limitations. Time-multiplexing may require high-speed spatial light modulators, which may often be impractical for real-time applications, while partial spatial coherence methods may reduce image resolution and depth of field. Multisource illumination techniques, though effective, may rely on complex hardware configurations and may typically be constrained to time-sequential color reproduction. These limitations may hinder the widespread adoption of holographic displays in applications such as augmented reality, virtual reality, and other near-eye display technologies, where high image quality and realistic depth perception may be essential. An approach is needed to address these challenges while preserving holographic depth cues and maintaining high image fidelity.

In some examples, holographic display apparatuses may utilize multiple wavelengths of light simultaneously to reduce speckle noise. These apparatuses may include a light source capable of generating several discrete wavelengths of light that are mutually incoherent, meaning the wavelengths may not interfere with one another. The selected wavelengths may be chosen from a broad spectrum, such as the visible range, and at least two wavelengths may be used for each frame of the display. The selection process may be optimized based on the desired image and scene requirements, ensuring that the chosen wavelengths are sufficiently decorrelated to minimize speckle noise. By carefully selecting and combining these wavelengths, the apparatus may achieve improved image clarity and reduced visual artifacts.

In some implementations, phase-only patterns may be computed for a spatial light modulator, which may be a device that adjusts the phase of light waves to shape their wavefronts. These phase patterns may be designed to ensure that the speckle fields generated by each wavelength are uncorrelated at the image plane, meaning the noise patterns from different wavelengths may not overlap. The apparatus may drive the selected wavelengths concurrently, rather than sequentially, enabling simultaneous multi-wavelength illumination. This simultaneous illumination creates intensities of the wavelengths that combine without interference (or with less interference), further contributing to speckle noise reduction. Additionally, the system may preserve holographic depth cues, ensuring that the optical fields maintain coherence for accurate depth and defocus cues in the resulting images.

In some implementations, a dual spatial light modulator architecture may be employed, where two spatial light modulators are positioned with a spatial separation between them. This configuration may help break wavelength-dependent correlations, enabling more effective averaging of speckle fields. The dual spatial light modulator setup may provide additional degrees of freedom for shaping the wavefronts of the selected wavelengths, enhancing the system's ability to reduce speckle noise. To simulate the behavior of light as it propagates between the spatial light modulators and the image plane, an angular spectrum propagation model may be used. This model may account for variations in the phase and amplitude of light waves that depend on the wavelength, ensuring accurate wavefront shaping and improved image quality.

In some examples, the wavelengths and their amplitudes may be optimized for each frame to achieve the desired balance between image quality and speckle reduction. This optimization process may consider factors such as the target image, the content of the scene, and the constraints of the hardware. The choice of wavelengths may be important for ensuring that the speckle fields are decorrelated and that the colors in the image are accurately reproduced. A calibration process may also be included to model the wavelength-dependent behavior of the light source, spatial light modulators, and other optical components. This calibration may involve learning the amplitude and optical path difference for each wavelength, as well as accounting for optical effects such as aberrations, which may be distortions caused by imperfections in the optical system.

In some implementations, look-up tables may be used to map grayscale input values to phase shifts for the spatial light modulators. These look-up tables may be specific to each wavelength and may be learned during the calibration process. They may account for quantization effects, which occur when continuous values are approximated by discrete levels, as well as higher-order optical phenomena. Aperture aberrations, which may be distortions caused by the aperture through which light passes, may also be modeled using mathematical functions such as Zernike polynomials. This modeling may ensure that the propagation of light through the system is accurately represented, further improving the system's ability to reduce speckle noise and enhance image quality.

In some implementations, perceptual color modeling may be incorporated to ensure that the colors displayed by the holographic apparatus are accurately reproduced. The response of the human visual system to different wavelengths may be modeled using sensitivity functions for the three types of cone cells in the human eye: long-wavelength, medium-wavelength, and short-wavelength cones. These sensitivity functions may be used to convert the response into standard color spaces, such as red-green-blue (RGB) or International Commission on Illumination (CIE) XYZ, for perceptual accuracy. In other words, an apparatus disclosed herein can be configured so that its controller selects which discrete wavelengths to use according to a perceptual color objective grounded in human vision. The selection process incorporates the long-, medium-, and short-cone (LMS) eye response functions to weight how each wavelength contributes to perceived color. It further applies a differentiable color-space transformation, such as mapping LMS to XYZ and/or sRGB, so the wavelength choice can be embedded in a gradient-based optimization that targets accurate color reproduction while reducing speckle. In operation, the controller evaluates candidate wavelength sets and chooses those that, together with the computed modulation, best reproduce the target scene's colors in a perceptually faithful manner and support decorrelation of wavelength-dependent speckle fields.

The performance of the holographic display may also be optimized by minimizing the difference between the desired image and the output of the apparatus. This optimization may involve selecting wavelengths, adjusting their amplitudes, and computing phase patterns for the spatial light modulators, balancing speckle reduction, color fidelity, and overall image quality.

In some implementations, experimental validation may be conducted using a prototype system. This prototype may include a light source capable of generating a broad spectrum of wavelengths, a dual spatial light modulator setup, and a camera sensor for capturing images. Experimental results demonstrate significant reductions in speckle noise and improved image quality compared to conventional holographic methods. The prototype may also be used to capture high-quality two-dimensional images and three-dimensional focal stacks, which are sets of images taken at different focus levels to create a sense of depth. These results may highlight the potential of the apparatus for applications requiring high-resolution and immersive visual experiences.

In some embodiments, a trade-off may exist between speckle reduction and the range of colors that can be displayed. Increasing the number of wavelengths may enhance speckle reduction but may limit the ability to reproduce highly saturated colors. The apparatus may balance these trade-offs to achieve optimal performance for different images and scenes. Studies may also investigate the effects of wavelength selection and multiplexing on speckle reduction, showing that increasing the number of wavelengths and their spacing improves speckle reduction. Wavelength multiplexing, where multiple wavelengths are used simultaneously, may outperform time-sequential illumination in terms of speckle reduction and image quality.

In some examples, alternative configurations may be explored, such as using a single spatial light modulator instead of a dual spatial light modulator setup. A single spatial light modulator configuration may offer a simpler and more cost-effective design. Replacing one spatial light modulator with a static diffractive optical element may reduce system complexity while maintaining some ability to reduce speckle noise. These apparatuses may be particularly effective for displaying three-dimensional content, where speckle noise may be more pronounced. They may enable the creation of focal stacks with realistic blur, enhancing the immersive experience of holographic displays.

In some aspects, random phase holograms may be produced with uniform intensity across the viewing area, reducing artifacts and improving the viewing experience for applications where the position of the viewer's eye may vary. Polychromatic illumination may be integrated into holographic displays, enabling the use of wavelength diversity to reduce speckle noise and reproduce colors. The use of more than three discrete laser sources may be proposed as a feasible path for future implementations. A hyperspectral forward model may also be employed to simulate the propagation of light and optimize the performance of the display. This model may incorporate wavelength-dependent parameters to ensure accurate representation of the holographic system.

In some implementations, a calibration procedure may involve capturing pairs of spatial light modulator patterns and their corresponding images, then optimizing the parameters of the model using computational methods. This procedure may ensure precise alignment of the components and accurate representation of optical effects. Improvements in speckle reduction and image quality may be demonstrated for both two-dimensional and three-dimensional holographic displays. These apparatuses may achieve high values of peak signal-to-noise ratio, which is a measure of image quality, and reduced speckle noise. Additional approaches may involve miniaturization, real-time computation, and advanced color modeling in a manner that enables practical use of holographic displays in commercial near-eye applications, while investigating trade-offs between speckle reduction, color accuracy, and system complexity.

Aspects of the subject matter described in this disclosure can be implemented to realize one or more of the following potential advantages. The described techniques may be implemented to support improved image clarity and reduced visual artifacts in holographic displays by leveraging wavelength diversity and simultaneous illumination. The use of polychromatic illumination may enable the creation of holographic images with enhanced depth cues and realistic defocus effects, which may improve the immersive experience for viewers. The optimization of wavelengths and amplitudes may allow for tailored performance based on specific scene requirements, ensuring that speckle noise is minimized while maintaining accurate color reproduction. A dual spatial light modulator architecture may provide additional degrees of freedom for wavefront shaping, which may enhance the system's ability to decorrelate speckle fields and improve image quality. Calibration procedures may ensure precise alignment and accurate modeling of optical effects, which may contribute to the robustness and reliability of the holographic apparatus.

Aspects of the disclosure are initially described in the context of holographic display apparatuses. Aspects of the disclosure are additionally illustrated by and described with reference to example implementations. Aspects of the disclosure are further illustrated by and described with reference to a flowchart that relates to methods involving polychromatic illumination for speckle control in holographic displays and creating systems for the same.

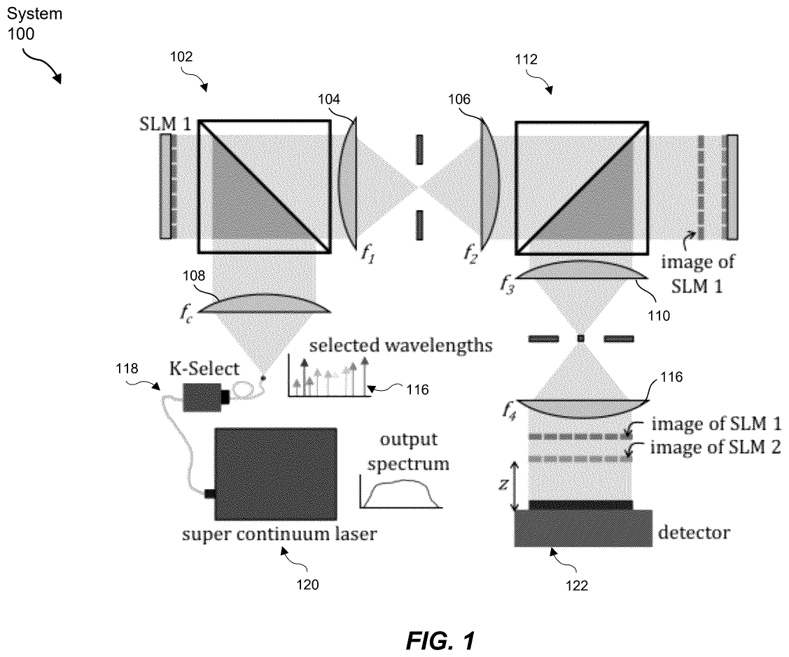

FIG. 1 shows experimental setup schematic 100 that supports techniques for polychromatic illumination for speckle control in holographic displays in accordance with various aspects of the present disclosure. As depicted in FIG. 1, the experimental setup schematic 100 may include one or more of a modulation stage 102, an optical element 104, an optical element 106, an optical element 108, an optical element 110, a phase only modulation stage 112, an optical element 114, selected wavelengths 116, a wavelength selection module 118, an illumination source 120, a detector 122, and/or other components.

Modulation stage 102 may include a spatial light modulator configured to manipulate light waves for holographic display applications. The modulation stage 102 may consist of a modulation device capable of altering the phase of incoming light waves without affecting their amplitude. Modulation stage 102 may be positioned to receive light from illumination source 120 and may be controlled by the control circuitry to apply specific phase modulation patterns. In some implementations, modulation stage 102 may be a liquid crystal on silicon (LCoS) device or a digital micromirror device (DMD), depending on the system requirements.

Optical element 104 may represent a lens positioned to focus light from modulation stage 102 onto the subsequent optical components. Optical element 104 may have a focal length that determines the convergence of light waves emerging from modulation stage 102. Optical element 104 may work in conjunction with optical element 106 to relay the modulated light to optical element 108. In some implementations, optical element 104 may be a plano-convex lens or a biconvex lens, depending on the optical design.

Optical element 106 may provide a second lens that works in conjunction with optical element 104 to relay light to optical element 108. Optical element 106 may be positioned at a specific distance from optical element 104 to ensure proper collimation or focusing of the light. Optical element 106 may be designed to handle the specific wavelength range emitted by illumination source 120. In some implementations, optical element 106 may be an achromatic doublet lens to reduce chromatic aberrations.

Optical element 108 may include an optical component designed to filter specific frequencies or components of light. Optical element 108 may be configured to block unwanted spectral components or higher-order diffraction patterns from the light modulated by modulation stage 102. Optical element 108 may be positioned between optical element 106 and optical element 110 to ensure that only the desired wavelengths are transmitted to the next stage. In some implementations, optical element 108 may be a bandpass filter or a spatial filter.

Optical element 110 may represent a lens positioned to relay light from optical element 108 to modulation stage 112. Optical element 110 may have a specific focal length to ensure that the filtered light is properly directed onto modulation stage 112. Optical element 110 may be aligned with the optical axis of the system to maintain the integrity of the light wavefront. In some implementations, optical element 110 may be a high-precision lens designed to minimize optical aberrations.

Modulation stage 112 may include a spatial light modulator configured to manipulate light waves for holographic imaging. Modulation stage 112 may receive light from optical element 110 and apply modulation patterns as determined by the control circuitry. While some examples implement phase-only modulation, other modalities can be employed. For example, an amplitude-only modulator can be used and may achieve comparable speckle-reduction performance. As another example, hybrid stages capable of simultaneous phase-and-amplitude control can also be used. Modulation stage 112 may be positioned in a dual-SLM configuration with modulation stage 102 to enhance decorrelation of wavelength-dependent speckle fields or implemented as a single SLM paired with a diffractive optical element. In some implementations, modulation stage 112 may also be implemented with more than two modulators.

Optical element 114 may represent a lens that relays light from modulation stage 112 to detector 122. Optical element 114 may be positioned to focus the modulated light onto detector 122 for image capture. Optical element 114 may be designed to handle the specific wavelength range of selected wavelengths 116. In some implementations, optical element 114 may be a high-quality imaging lens with anti-reflective coatings to minimize light loss.

Selected wavelengths 116 may include a set of discrete wavelengths chosen for polychromatic illumination. Selected wavelengths 116 may be determined by the wavelength selection module 118 based on the requirements of the holographic display. Selected wavelengths 116 may be mutually incoherent to reduce speckle noise at the image plane. In some implementations, selected wavelengths 116 may span the visible spectrum or be optimized for specific color reproduction needs.

The wavelength selection module 118 may represent a system configured to determine and control the specific wavelengths used for illumination. The wavelength selection module 118 may include components such as diffraction gratings or tunable filters to isolate the desired wavelengths from the broad spectrum emitted by illumination source 120. The wavelength selection module 118 may be controlled by the control circuitry to dynamically adjust selected wavelengths 116. In some implementations, the wavelength selection module 118 may be integrated with illumination source 120 for compactness.

Illumination source 120 may include a supercontinuum laser capable of emitting a broad spectrum of light. Illumination source 120 may generate light that spans a wide range of wavelengths, including the visible spectrum. Illumination source 120 may be coupled with the wavelength selection module 118 to produce selected wavelengths 116 for holographic display applications. In some implementations, illumination source 120 may be replaced with a set of discrete laser diodes emitting at specific wavelengths.

Detector 122 may include a sensor configured to capture light waves and record holographic images. Detector 122 may be positioned to receive light relayed by optical element 114 and may convert the optical signals into digital data for further processing. Detector 122 may be controlled by the control circuitry to synchronize image capture with the operation of illumination source 120 and modulation stage 102 and modulation stage 112. In some implementations, detector 122 may be a high-resolution monochrome camera or a color camera with a Bayer filter array.

In some implementations, illumination source 120 may emit a broad spectrum of light that passes through the wavelength selection module 118, which may filter and select discrete wavelengths 116 for subsequent processing. Selected wavelengths 116 may then propagate toward the spatial light modulator modulation stage 102, where phase-only or other modulation patterns may be applied to modulate the wavefronts of the incoming light. The modulated light may then pass through optical lens 104, which may focus the light onto the Fourier plane, where higher-order aberrations may be removed by an iris.

In some examples, the light may continue through the optical lens 106, which may relay the modulated wavefronts to the second spatial light modulator modulation phase 112. Modulation stage 112 may apply additional phase modulation to further decorrelate the speckle fields across selected wavelengths 116. The modulated light may then pass through the optical lens 110, which may focus the light onto another Fourier plane, where a DC filter may block unwanted components. The light may then propagate through the optical lens 114, which may relay the combined wavefronts to detector 122 mounted on a linear motion stage.

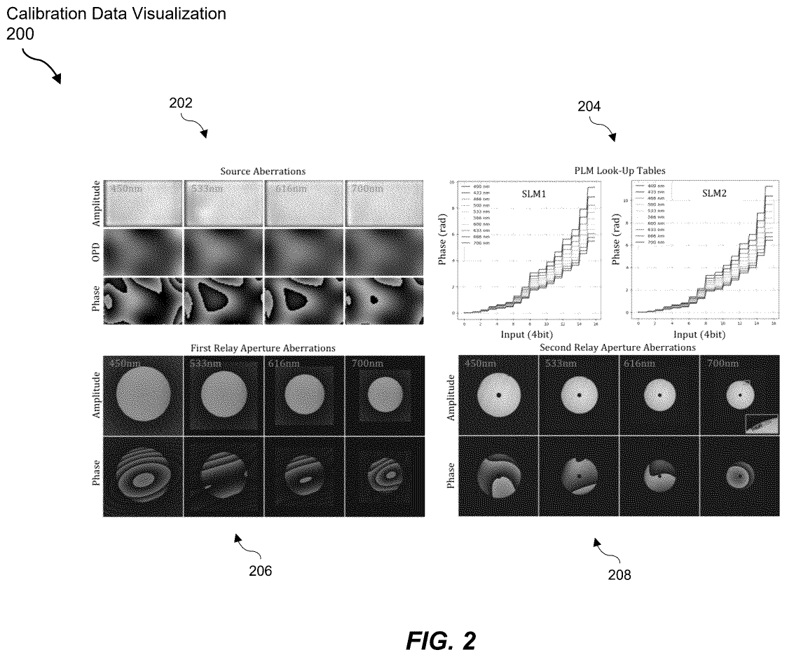

FIG. 2 shows calibration data visualization 200 that supports techniques for polychromatic illumination for speckle control in holographic displays in accordance with various aspects of the present disclosure. As depicted in FIG. 2, calibration data visualization 200 may include one or more of source aberrations 202, PLM look-up tables 204, first relay aperture aberrations 206, and second relay aperture aberrations 208.

Source aberrations 202 may represent wavelength-dependent optical path differences that influence the holographic field. Source aberrations 202 may include variations in the phase and amplitude of the light field as a function of wavelength. These aberrations may arise due to imperfections in the optical components or the inherent properties of the illumination subsystem. The source aberrations 202 may interact with the modulation stage to affect the coherence and spatial distribution of the holographic field. In some implementations, source aberrations 202 may be modeled using Zernike polynomials to represent the optical path differences across the aperture.

PLM look-up tables 204 may include mappings of grayscale input values to phase shifts for various wavelengths. PLM look-up tables 204 may store pre-determined values that correspond to the phase modulation required for each grayscale input at specific wavelengths. These mappings may account for the wavelength-dependent behavior of the phase light modulators, ensuring accurate phase modulation. PLM look-up tables 204 may be used in conjunction with the control circuitry to determine the appropriate modulation patterns for the modulation stage. In some implementations, PLM look-up tables 204 may be calibrated for a range of wavelengths using a hyperspectral model to account for chromatic dispersion.

First relay aperture aberrations 206 may determine spatial frequency cut-offs for the holographic field during propagation. First relay aperture aberrations 206 may include amplitude transmission and optical path differences that vary across the aperture. These aberrations may influence the angular spectrum propagation of the holographic field between the first and second spatial light modulators. First relay aperture aberrations 206 may be modeled as a complex pupil function that incorporates both amplitude and phase components. In some implementations, the first relay aperture aberrations 206 may be learned through a calibration procedure that uses experimentally captured SLM-image pairs.

Second relay aperture aberrations 208 may account for amplitude transmission and optical path differences across wavelengths. Second relay aperture aberrations 208 may include wavelength-dependent variations in the spatial frequency cut-off and phase retardation. These aberrations may affect the propagation of the holographic field from the second spatial light modulator to the image plane. Second relay aperture aberrations 208 may be represented using a separable basis of Zernike polynomials and wavelength-dependent scaling factors. In some implementations, second relay aperture aberrations 208 may include a DC-filter term to block unmodulated light and higher-order diffraction components.

In some implementations, source aberrations 202 may represent the amplitude, optical path difference (OPD), and phase characteristics of the light emitted by the supercontinuum laser source. These aberrations may be learned at specific anchor wavelengths, such as 450 nm, 533 nm, 616 nm, and 700 nm, and may be used to model the wavelength-dependent behavior of the source field. The PLM look-up tables 204 may define the mapping between the digital input values and the corresponding phase modulation for the two phase light modulators (SLM1 and SLM2). These look-up tables may account for the non-linear response of the PLMs and may vary across wavelengths to accommodate the spectral characteristics of the system.

In some implementations, first relay aperture aberrations 206 may represent the amplitude and phase distortions introduced by the optical elements in the first relay system. These aberrations may be modeled using Zernike polynomials to capture the wavelength-dependent variations in the optical path. The second relay aperture aberrations 208 may include additional amplitude and phase distortions, as well as a DC-filter term that may block the direct current component in the Fourier plane. The second relay system may incorporate a physical DC filter, such as one manufactured by Thorlabs, which may introduce fine details in the Fourier domain that are reconstructed during the calibration process.

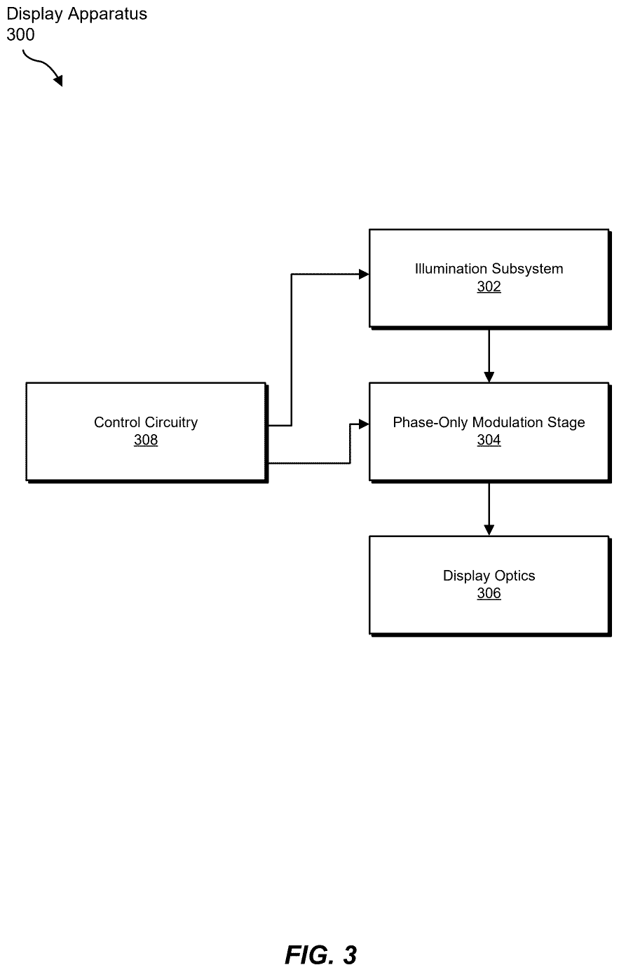

FIG. 3 depicts an example display apparatus 300 that implements the foregoing techniques and may be programmed using the calibration framework of FIG. 1. As shown, apparatus 300 may include an illumination subsystem 302, a modulation stage 304, display optics 306, and control circuitry 308. Illumination subsystem 302 may comprise one or more emitters together with wavelength-selection elements that, under command of control circuitry 308, provide a plurality of mutually incoherent spectral components at discrete wavelengths. In some examples, illumination subsystem 302 may include a supercontinuum source with a tunable selection module, or a plurality of independent narrowband lasers combined through dichroics, each channel being individually addressable for per-wavelength activation and amplitude setting.

Modulation stage 304 may be positioned to receive light from illumination subsystem 302 and may include a single spatial light modulator or a dual-SLM cascade separated by a non-zero propagation distance. In a dual-SLM implementation, stage 304 may be configured to apply respective, wavelength-aware modulation patterns that decorrelate wavelength-dependent speckle fields, as learned by the calibration of FIG. 1. Control circuitry 308 may compute these modulation patterns using a hyperspectral forward model that incorporates wavelength-dependent source aberrations, per-device look-up tables mapping drive codes to phase, and relay aperture aberrations parameterized, for example, by Zernike polynomials. The same control circuitry 308 may select at least two of the discrete wavelengths and direct illumination subsystem 302 to illuminate modulation stage 304 with the selected wavelengths effectively concurrently within an integration interval while applying the computed patterns.

Display optics 306 may relay and condition the modulated light toward an image plane. In some embodiments, display optics 306 may include one or more Fourier-plane apertures or DC obscurations to suppress unmodulated components and higher-order diffraction, with passbands and optical path differences matched to the wavelength-dependent calibration learned in FIG. 1. A Fourier-plane aperture may be an optical stop or mask placed at the plane where a lens forms the spatial-frequency (Fourier) spectrum of an input field and may be implemented in the intermediate plane in a multi-lens relay. At this plane, each point corresponds to a spatial frequency component of the wavefront; the aperture selectively transmits or blocks components to shape the field. The optical train may be configured to project a two-dimensional image or a focal stack with realistic defocus cues, and may be adapted for near-eye coupling, such as into a waveguide having in-coupling and out-coupling gratings sized to provide a uniform eyebox.

In operation, control circuitry 308 may retrieve FIG. 1 calibration parameters including source amplitude and optical path difference across anchor wavelengths, wavelength-dependent phase look-up tables for the modulator(s), relay aperture amplitude and phase terms, and alignment transforms between cascaded modulators. Using these parameters, control circuitry 308 may determine a subset of discrete wavelengths, compute modulation patterns (and, in some cases, per-wavelength amplitude weights), and synchronize concurrent wavelength activation with application of the computed patterns at stage 304. As a result, intensities from the concurrently illuminated, mutually incoherent wavelengths may incoherently sum at the image plane in a manner that reduces speckle while preserving holographic depth cues. Apparatus 300 thus provides a compact functional block architecture that can be calibrated using the FIG. 1 procedure and then driven in real time to realize polychromatic illumination for speckle control.

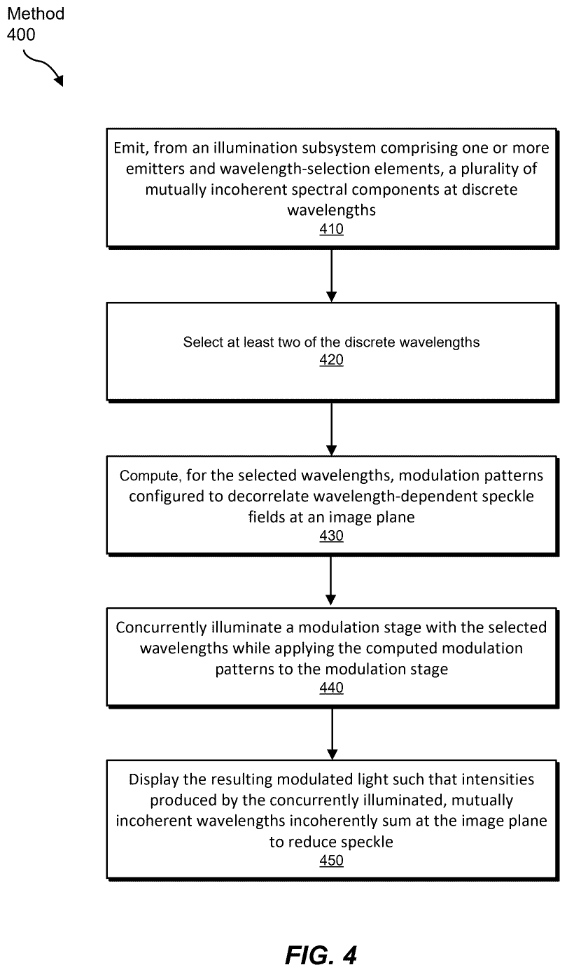

FIG. 4 illustrates a method 400 that can be implemented using the apparatus of FIG. 3 and programmed by the calibration framework of FIG. 1. Method 400 operationalizes polychromatic illumination to reduce speckle while preserving holographic depth cues. Each step is coordinated by control circuitry using hyperspectral calibration parameters, wavelength-aware look-up tables, and relay aperture models so that concurrently activated, mutually incoherent wavelengths incoherently sum at the image plane.

Step 410 (Emit spectral components). The illumination subsystem emits a plurality of spectral components at discrete wavelengths that are mutually incoherent. In some examples, a supercontinuum source with a tunable selection module generates a broad spectrum from which narrow bands are made available; in other examples, independent narrowband lasers provide discrete lines. The subsystem establishes per-band launch conditions (e.g., beam quality, polarization state, and initial amplitude settings) that are consistent with factory calibration so the selected components can be addressed individually and combined along a shared optical path for subsequent modulation.

Step 420 (Select discrete wavelengths). The control circuitry selects at least two of the available discrete wavelengths for a display interval. Selection can be scene-adaptive, based on a perceptual color objective and speckle-reduction criteria derived from the calibrated hyperspectral model, or predetermined for a given content profile. The selection ensures sufficient spectral separation and decorrelation potential. In some examples, selection also schedules temporal frames and focal planes, so wavelength sets are reused or updated across a focal stack.

Step 430 (Compute modulation patterns). For the selected wavelengths, the control circuitry computes modulation patterns (e.g., for a dual-SLM cascade) using a calibrated forward model that incorporates source OPD and amplitude terms, wavelength-dependent SLM LUTs, relay aperture aberrations parameterized by Zernike polynomials, and alignment transforms. The computation can solve for per-wavelength phase patterns configured to decorrelate wavelength-dependent speckle fields at the image plane and to reconstruct the target scene (e.g., a 2D image or focal stack). In some implementations, the computation also determines per-wavelength amplitude settings and applies LMS-based perceptual weighting and differentiable color transforms to balance speckle reduction with color fidelity.

Step 440 (Concurrently illuminate and apply modulation). The control circuitry directs the illumination subsystem to illuminate the modulation stage with the selected wavelengths effectively concurrently within an integration interval while applying the computed modulation patterns. Concurrency ensures that multiple mutually incoherent spectral components are on during the same display interval, and synchronization aligns wavelength activation with SLM refresh to suppress DC leakage and unwanted orders. In a dual-SLM architecture, respective phase maps are applied to both modulators with proper alignment; relay apertures filter higher-order diffraction and unmodulated components as the doubly modulated wavefront propagates toward the image plane.

Step 450 (Display and incoherently sum). The display optics relay and condition the modulated light such that intensities from the concurrently illuminated, mutually incoherent wavelengths incoherently sum at the image plane to reduce speckle. Because the spectral components do not maintain fixed phase relationships, cross-interference terms average out within the sensor or retinal integration time, and the decorrelated speckle fields collapse in intensity. The resulting image preserves random-phase hologram depth cues and can be presented as a 2D frame or as a focal stack with natural defocus, with uniform eyebox intensity supported by the wavefront design and aperture filtering learned during calibration. A random-phase hologram may be a holographic reconstruction generated from patterns whose pixelwise phases are distributed to appear statistically random, producing uniform eyebox intensity and realistic accommodation cues while minimizing structured artifacts.

The phrase “manner that reduces speckle” may generally refer to operating conditions and control actions under which the granular interference artifacts (speckle) produced by coherent illumination are suppressed in the perceived or captured image. In the disclosed technology, speckle reduction is achieved by causing multiple, mutually incoherent speckle realizations to be present during the same display interval and to add in intensity rather than interfere in phase. When the speckle fields are sufficiently decorrelated—across wavelength, source position, or other diversity dimensions—the cross-terms average out within the sensor or retinal integration time, and the summed intensities exhibit reduced contrast relative to any single speckle realization.

One example is wavelength multiplexing. The illumination subsystem provides discrete spectral components (e.g., 520 nm, 580 nm, 650 nm) that are mutually incoherent. The control circuitry selects at least two wavelengths and concurrently illuminates the modulator while applying wavelength-aware phase-only patterns. Each wavelength produces a different speckle field at the image plane due to wavelength-dependent propagation and modulation. Because the components are mutually incoherent, their intensities add: Iₜₒₜₐₗ=Σ□I_{λ}_{ᵢ}. The resulting speckle contrast decreases approximately with the square root of the number of independent components, so driving 8 decorrelated wavelengths yields noticeably smoother images than 3-primary RGB.

Another example is angular (multisource) diversity. A plurality of spatially separated illumination sources are activated together, each launching light along a distinct path so the speckle patterns differ in phase and geometry. The controller computes source weights and modulator patterns to decorrelate speckle across source positions, again causing intensities to add: Iₜₒₜₐₗ=Σ□I_{source}_{ⱼ}. Combining angular diversity with wavelength multiplexing provides two orthogonal diversity axes (spectral and spatial), further reducing speckle through additive averaging of independent fields.

A complementary example involves a dual-SLM (or SLM+DOE) architecture. Two phase modulation planes separated by a non-zero distance break wavelength-dependent “memory effects,” increasing the statistical independence of speckle across wavelengths. The controller computes respective phase maps so that, after cascaded modulation and relay filtering, the speckle fields from different wavelengths are uncorrelated at the image plane. This configuration enhances the effectiveness of incoherent summation without requiring higher SLM speeds.

Finally, perceptual and hardware-aware adjustments can operate in a manner that reduces speckle. Scene-adaptive wavelength selection favors spectral sets with larger separations; per-wavelength amplitude weights limit dominance by any single component; Fourier-plane apertures suppress unmodulated/DC content and high-order diffraction that can exacerbate speckle; and synchronization of wavelength activation with modulator refresh prevents leakage that reintroduces coherent artifacts. Across these examples, the unifying principle is deliberate creation and concurrent presentation of multiple, mutually incoherent, decorrelated speckle fields whose intensities incoherently sum, lowering speckle contrast while preserving holographic depth cues.

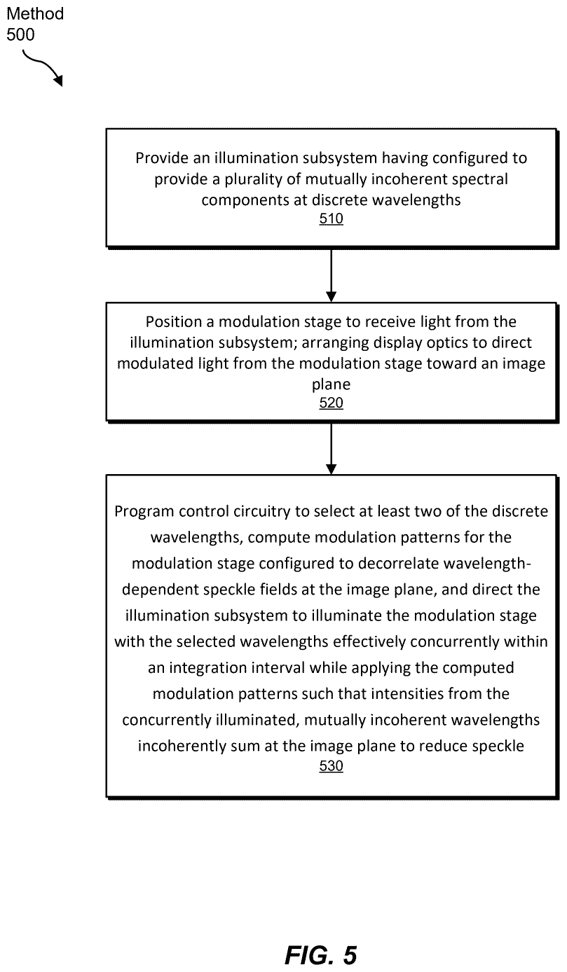

FIG. 5 illustrates a method 500 that can be implemented to manufacture a system like the apparatus of FIG. 3 and to configure that system to perform the operational method of FIG. 4. Method 500 organizes assembly and programming tasks so that the resulting hardware provides concurrently activated, mutually incoherent spectral components at discrete wavelengths, applies wavelength-aware modulation learned from calibration, and delivers modulated light toward an image plane with speckle reduced by incoherent summation.

Step 510 (Provide illumination subsystem). The manufacturing process provides an illumination subsystem configured to provide a plurality of mutually incoherent spectral components at discrete wavelengths. In some examples, the subsystem may include a supercontinuum source coupled to a tunable wavelength-selection module; in other examples, a plurality of independent narrowband emitters may be combined through dichroics or fiber couplers. Mechanical and optical integration may align launch optics, polarization conditioning, and beam shaping so the selected spectral components are co-propagated along a common path. Electrical integration may provision per-wavelength drivers and gating interfaces that support amplitude control and effective concurrency within an integration interval consistent with eye-safety and power constraints.

Step 520 (Position modulation stage and arrange display optics). The manufacturing process positions a modulation stage to receive light from the illumination subsystem and arranges display optics to direct modulated light toward an image plane. In some implementations, the modulation stage may include a single spatial light modulator; in other implementations, first and second spatial light modulators may be mounted with a non-zero propagation distance between them to break wavelength-dependent correlations. Relay optics may include one or more Fourier-plane apertures sized to suppress DC and higher-order diffraction, with optical path differences and passbands matched to wavelength-dependent calibration. Mechanical fixtures may locate lenses and apertures to maintain alignment tolerances learned during calibration, and optional near-eye coupling hardware, such as waveguides with in-coupling and out-coupling gratings, may be integrated to provide a uniform eyebox.

Step 530 (Program control circuitry). The manufacturing process programs control circuitry to select at least two discrete wavelengths, compute modulation patterns configured to decorrelate wavelength-dependent speckle fields at the image plane, and direct the illumination subsystem to illuminate the modulation stage with the selected wavelengths effectively concurrently within an integration interval while applying the computed patterns. Programming may load hyperspectral calibration parameters—including source amplitude and optical path difference across anchor wavelengths, wavelength-dependent look-up tables mapping drive codes to phase, relay aperture aberrations parameterized by Zernike polynomials, and alignment transforms between cascaded modulators—so that runtime computation reconstructs target imagery (e.g., two-dimensional frames or focal stacks) and synchronization aligns wavelength activation with modulator refresh. As a result, intensities from the concurrently illuminated, mutually incoherent wavelengths incoherently sum at the image plane in a manner that reduces speckle while preserving holographic depth cues, enabling the manufactured system to perform the method of FIG. 4.

As a continuation of method 500, the manufacturing process may integrate the holographic display apparatus into a near-eye display system by mounting the illumination subsystem, modulation stage, and display optics within an eyewear housing. Mechanical fixtures may secure emitters, wavelength-selection elements, and relay optics in a compact, thermally managed chassis that conforms to ergonomic constraints of head-worn devices. The modulation stage may be positioned to maintain calibrated optical path lengths and alignment tolerances learned during factory calibration, while cable harnesses and flex interconnects may route power and data to the control circuitry with strain relief and electromagnetic compatibility. The eyewear housing may incorporate shielding, heat spreading, and serviceable access points for calibration or replacement, and may include provisions for interpupillary distance adjustment, tilt, and temple arm ergonomics to maintain alignment of the optical train with the user's eyes.

The process may further couple the modulated light into a near-eye waveguide having in-coupling and out-coupling gratings arranged to deliver the modulated light toward an exit pupil sized to provide an eyebox. An in-coupling grating may receive the doubly modulated wavefront from the display optics, inject the light into the waveguide substrate, and condition the angular spectrum to support total internal reflection along the guided path. One or more out-coupling gratings may be patterned to extract the guided light with controlled angular and spatial distributions, forming an exit pupil matched to the calibrated eyebox geometry so that uniform intensity and accommodation cues are preserved across pupil positions. The grating parameters, such as period, duty cycle, depth, and apodization, may be selected to align with wavelength-dependent calibration, suppress unwanted diffraction orders, and maintain color balance across concurrently active, mutually incoherent wavelengths. Synchronization of wavelength activation with grating extraction may be coordinated by the control circuitry so that the incoherent summation realized at the image plane is delivered to the user's retina with reduced speckle and stable color reproduction.

Control circuitry refers to the hardware and/or software components that generate, coordinate, and apply the signals and data needed to operate the illumination subsystem, modulation stage, and display optics. In various embodiments, control circuitry can include one or more processors (e.g., CPUs, GPUs, DSPs, FPGAs, or ASICs) executing software modules for hologram computation, wavelength selection, and device calibration; microcontrollers and embedded firmware managing timing, gating, and per-wavelength power control; memory devices storing calibration parameters, look-up tables, and phase maps; haptic and sensor interfaces (e.g., eye tracking, IMUs, photodiodes) providing closed-loop feedback; and discrete or integrated electronic circuits such as drivers for laser diodes, tunable filters, VOAs, and SLM controllers. The control circuitry can be implemented as a system-on-chip, a distributed set of boards, or integrated into a wearable host, and may include communication interfaces (e.g., USB, BLE, Wi-Fi) to receive content and updates.

The disclosed techniques for polychromatic illumination provide a practical and scalable pathway to reduce speckle in holographic displays while preserving depth cues and color fidelity. By concurrently driving mutually incoherent spectral components and applying wavelength-aware modulation (optionally within a dual-SLM architecture and calibrated hyperspectral model), the apparatus and methods achieve incoherent summation at the image plane that suppresses granular artifacts across two-and three-dimensional content. The manufacturing and programming workflows further enable alignment, device-aware LUT mapping, and perceptual color modeling, supporting integration into compact near-eye systems. Collectively, these systems and methods advance holographic imaging quality beyond time-sequential paradigms and establish a foundation for high-resolution, immersive displays suitable for augmented-and virtual-reality applications, with methods of use and manufacture facilitating commercial deployment.

### Example Embodiments

[INVENTOR(S): THE FOLLOWING SECTION IS A RESTATEMENT OF THE CLAIMS FOR LEGAL PURPOSES. FEEL FREE TO SKIP OVER THIS SECTION AND FOCUS YOUR REVIEW ON THE CLAIMS]
Clause 1. A holographic display apparatus comprising: an illumination subsystem having one or more emitters and wavelength-selection elements configured to provide a plurality of mutually incoherent spectral components at discrete wavelengths; a modulation stage positioned to receive light from the illumination subsystem; display optics arranged to direct modulated light from the modulation stage toward the image plane; control circuitry configured to: select at least two of the discrete wavelengths and to compute modulation patterns for the modulation stage that decorrelate wavelength-dependent speckle fields at an image plane, and direct the illumination subsystem to illuminate the modulation stage with the selected wavelengths effectively concurrently within an integration interval and to apply the computed modulation patterns such that intensities from the concurrently illuminated, mutually incoherent wavelengths incoherently sum at the image plane in a manner that reduces speckle.
Clause 2. The apparatus of clause 1, wherein: the modulation stage comprises at least two spatial light modulators separated by a non-zero propagation distance; and the control circuitry is configured to compute respective modulation patterns for each of the modulators.
Clause 3. The apparatus of any of clauses 1-2, further comprising relay optics including at least one Fourier-plane aperture configured to filter unwanted diffraction orders or DC components while directing modulated light toward the image plane.
Clause 4. The apparatus of any of clauses 1-3, wherein the control circuitry is configured to: compute per-wavelength amplitude weights; and to drive the illumination subsystem according to the computed weights to further decorrelate wavelength-dependent speckle fields at the image plane.
Clause 5. The apparatus of any of clauses 1-4, wherein the control circuitry is configured to determine the selected wavelengths based on a perceptual color objective that incorporates long-, medium-, and short-cone eye response functions and a differentiable color-space transformation.
Clause 6. The apparatus of any of clauses 1-5, wherein the control circuitry is configured to map continuous phase values to modulator drive codes using a wavelength-dependent lookup table and to account for phase quantization when applying the computed modulation patterns.
Clause 7. The apparatus of any of clauses 1-6, wherein the control circuitry is configured to compute modulation patterns over a focal stack of planes to generate random-phase holograms that provide substantially uniform eyebox intensity.
Clause 8. The apparatus of any of clauses 1-7, wherein the illumination subsystem comprises a supercontinuum laser source coupled to a tunable wavelength-selection module configured to provide the plurality of mutually incoherent spectral components at the discrete wavelengths.
Clause 9. The apparatus of any of clauses 1-8, wherein: the one or more emitters and wavelength selection elements of the illumination subsystem comprise a plurality of spatially separated illumination sources; and the control circuitry is configured to direct the illumination subsystem to illuminate the modulation stage by effectively concurrently activating at least two of the spatially separated illumination sources together with the selected wavelengths.
Clause 10. A method of reducing speckle in a holographic display, the method comprising: emitting, from an illumination subsystem comprising one or more emitters and wavelength-selection elements, a plurality of mutually incoherent spectral components at discrete wavelengths; selecting at least two of the discrete wavelengths; computing, for the selected wavelengths, modulation patterns configured to decorrelate wavelength-dependent speckle fields at an image plane; concurrently illuminating a modulation stage with the selected wavelengths while applying the computed modulation patterns to the modulation stage; and displaying the resulting modulated light such that intensities produced by the concurrently illuminated, mutually incoherent wavelengths incoherently sum at the image plane to reduce speckle.
Clause 11. The method of clause 10, further comprising: computing per-wavelength amplitude weights; and illuminating the modulation stage with the selected wavelengths using the computed per-wavelength amplitude weights.
Clause 12. The method of any of clauses 10-11, wherein computing per-wavelength amplitude weights comprises determining source drive settings for individual emitters or spectral bands such that wavelength-dependent speckle fields are further decorrelated at the image plane.
Clause 13. The method of any of clauses 10-12, wherein: the modulation stage comprises first and second spatial light modulators separated by a non-zero propagation distance, and computing the modulation patterns comprises computing respective patterns for the first and second modulators.
Clause 14. The method of any of clauses 10-13, further comprising: relaying light between the modulators and toward the image plane through relay optics that include at least one Fourier-plane aperture; and filtering unwanted diffraction orders or DC components with the aperture during the displaying.
Clause 15. The method of any of clauses 10-14, wherein concurrently illuminating comprises illuminating at least two of the selected wavelengths at least substantially concurrently or within an integration interval shorter than a retinal integration time.
Clause 16. The method of any of clauses 10-15, further comprising computing spectral weighting based on long-, medium-, and short-cone eye response functions.
Clause 17. The method of any of clauses 10-16, wherein computing the modulation patterns comprises computing over a focal stack of planes to produce random-phase holograms with substantially uniform eyebox intensity.
Clause 18. The method of any of clauses 10-17, wherein applying the computed modulation patterns comprises mapping continuous phase values to modulator drive codes using a wavelength-dependent lookup table and modeling quantization with a straight-through estimator.
Clause 19. A method of manufacturing a holographic display apparatus, the method comprising: providing an illumination subsystem having configured to provide a plurality of mutually incoherent spectral components at discrete wavelengths; positioning a modulation stage to receive light from the illumination subsystem; arranging display optics to direct modulated light from the modulation stage toward an image plane; programming control circuitry to: select at least two of the discrete wavelengths, compute modulation patterns for the modulation stage configured to decorrelate wavelength-dependent speckle fields at the image plane, and direct the illumination subsystem to illuminate the modulation stage with the selected wavelengths effectively concurrently within an integration interval while applying the computed modulation patterns such that intensities from the concurrently illuminated, mutually incoherent wavelengths incoherently sum at the image plane to reduce speckle.
Clause 20. The method of clause 19, further comprising: integrating the holographic display apparatus into a near-eye display system by mounting the illumination subsystem, modulation stage, and display optics within eyewear housing; and coupling the modulated light into a near-eye waveguide having in-coupling and out-coupling gratings arranged to deliver the modulated light toward an exit pupil sized to provide an eyebox.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed-or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

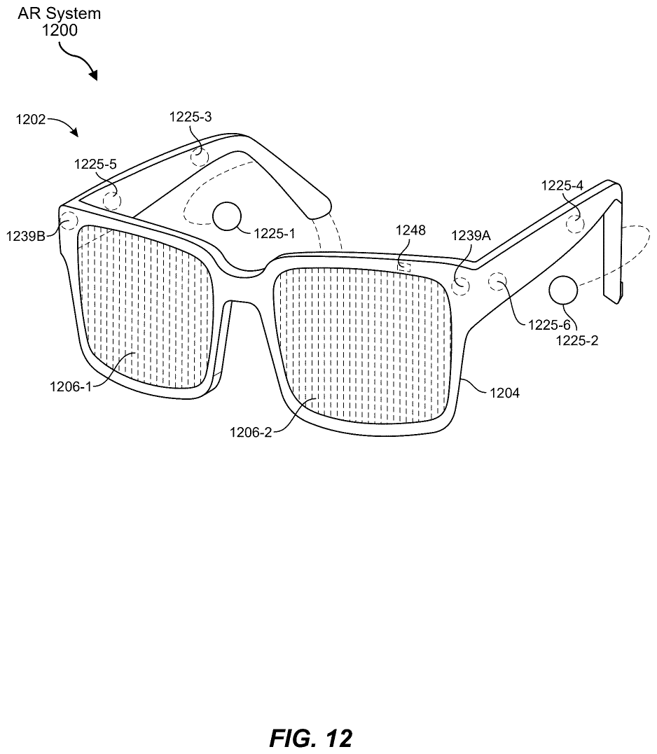

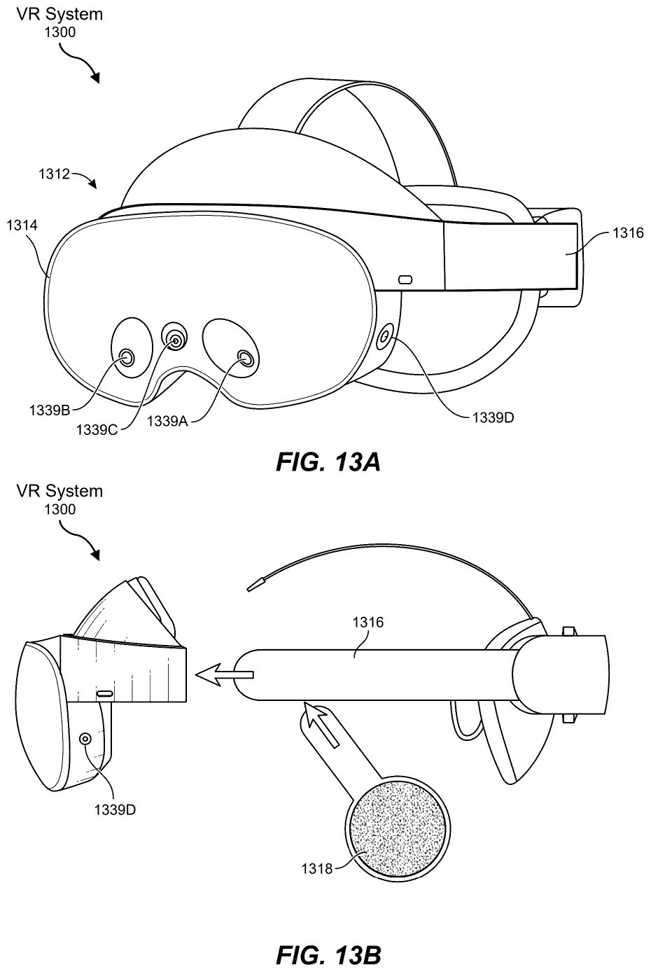

AR systems may be implemented in a variety of different form factors and configurations. Some AR systems may be designed to work without near-eye displays (NEDs). Other AR systems may include a NED that also provides visibility into the real world (such as, e.g., augmented-reality system 1200 in FIG. 12) or that visually immerses a user in an artificial reality (such as, e.g., virtual-reality system 1300 in FIGS. 13A and 13B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

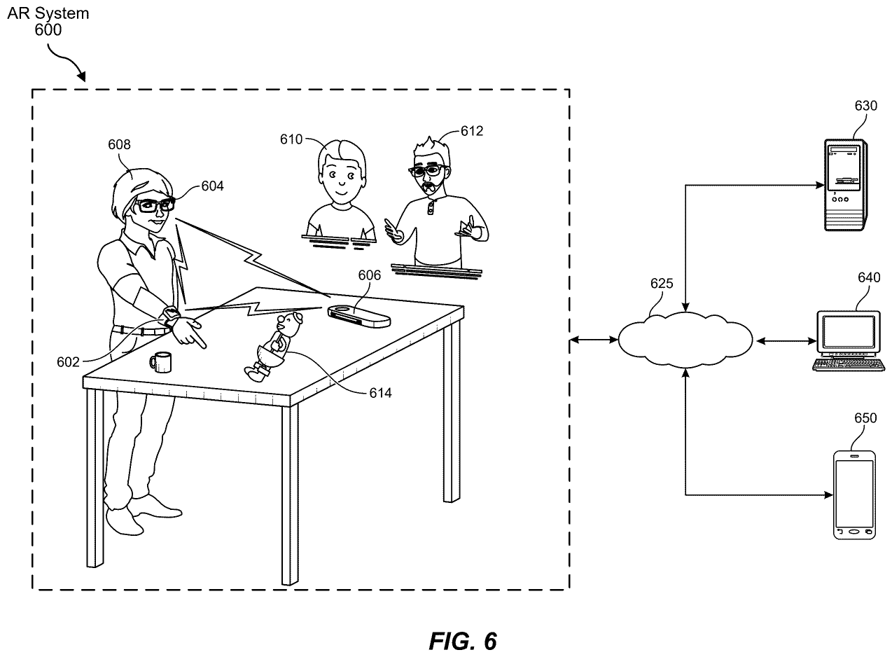

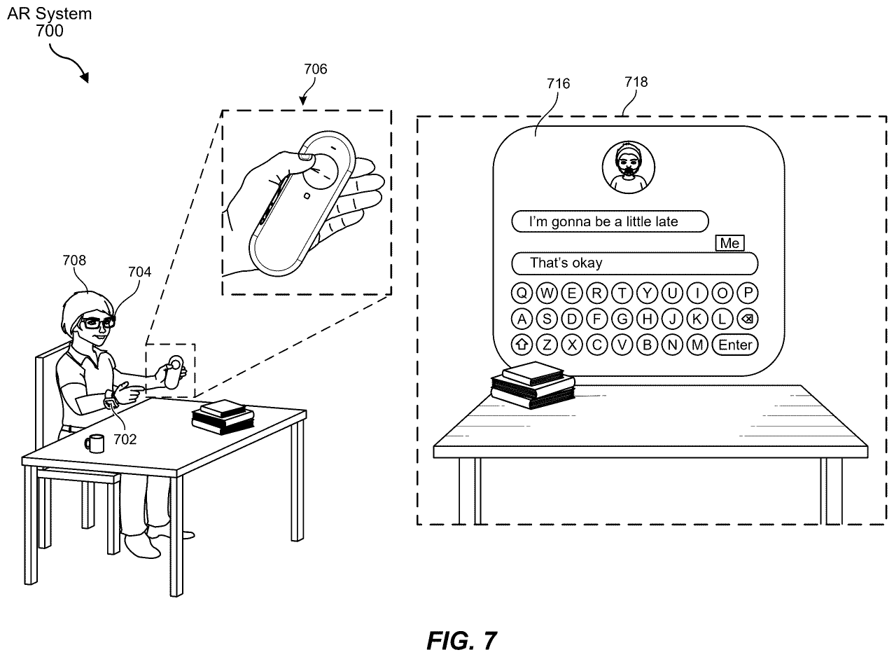

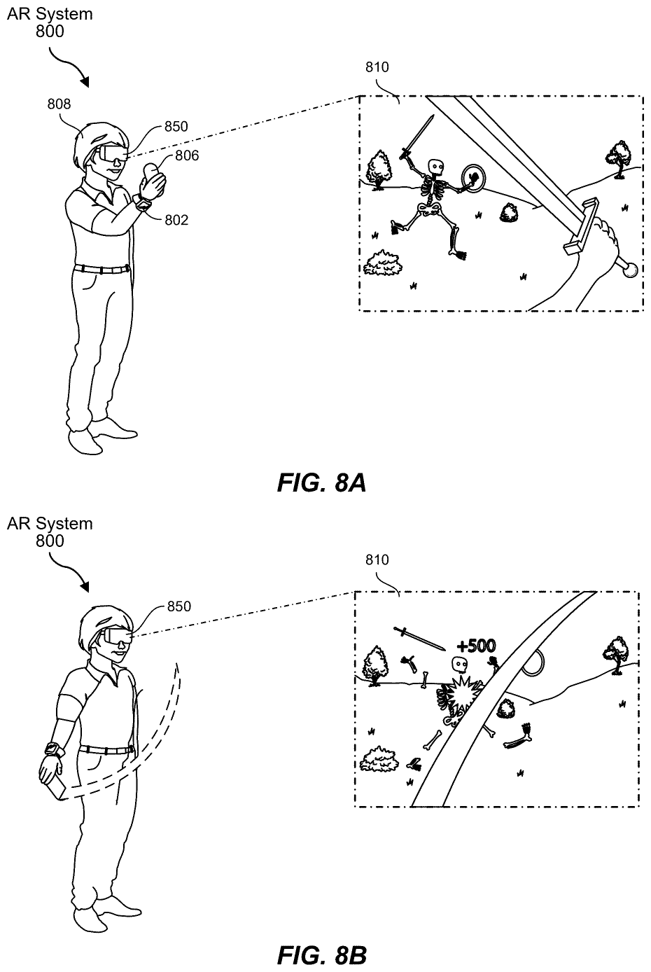

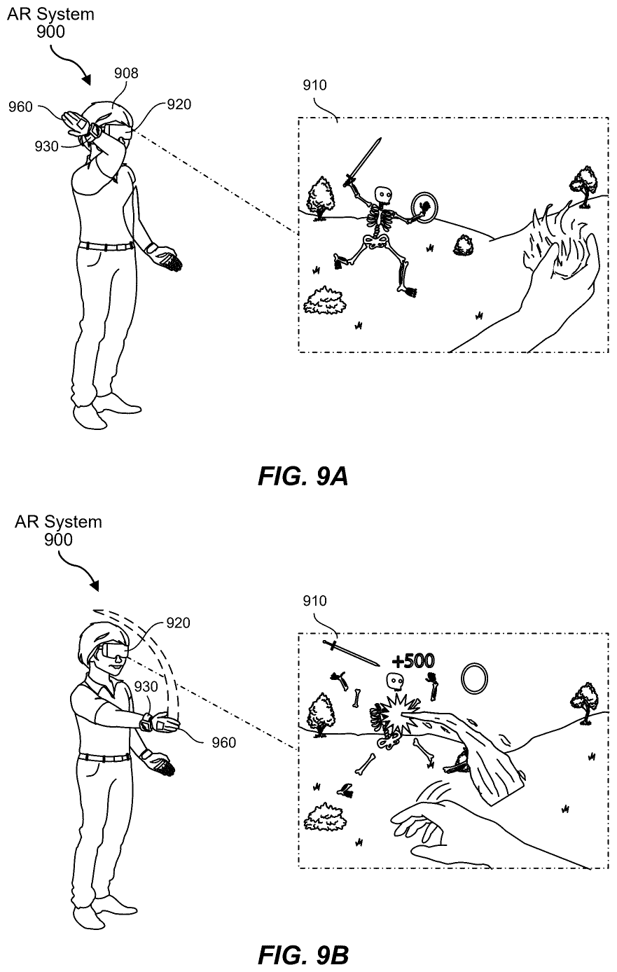

FIGS. 6-9B illustrate example artificial-reality (AR) systems in accordance with some embodiments. FIG. 6 shows a first AR system 600 and first example user interactions using a wrist-wearable device 602, a head-wearable device (e.g., AR glasses 1200), and/or a handheld intermediary processing device (HIPD) 606. FIG. 7 shows a second AR system 700 and second example user interactions using a wrist-wearable device 702, AR glasses 704, and/or an HIPD 706. FIGS. 8A and 8B show a third AR system 800 and third example user 808 interactions using a wrist-wearable device 802, a head-wearable device (e.g., VR headset 850), and/or an HIPD 806. FIGS. 9A and 9B show a fourth AR system 900 and fourth example user 908 interactions using a wrist-wearable device 930, VR headset 920, and/or a haptic device 960 (e.g., wearable gloves).

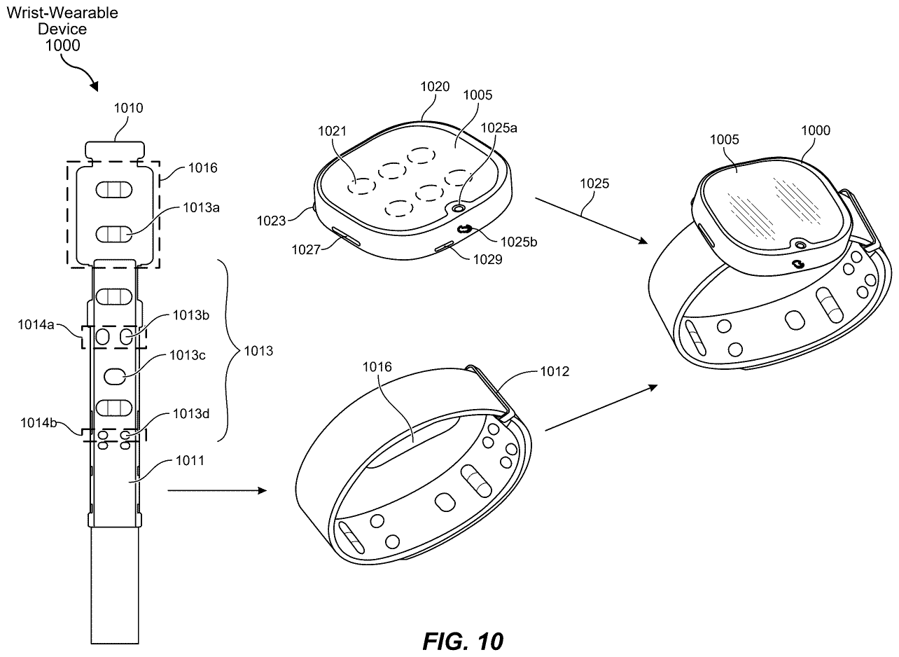

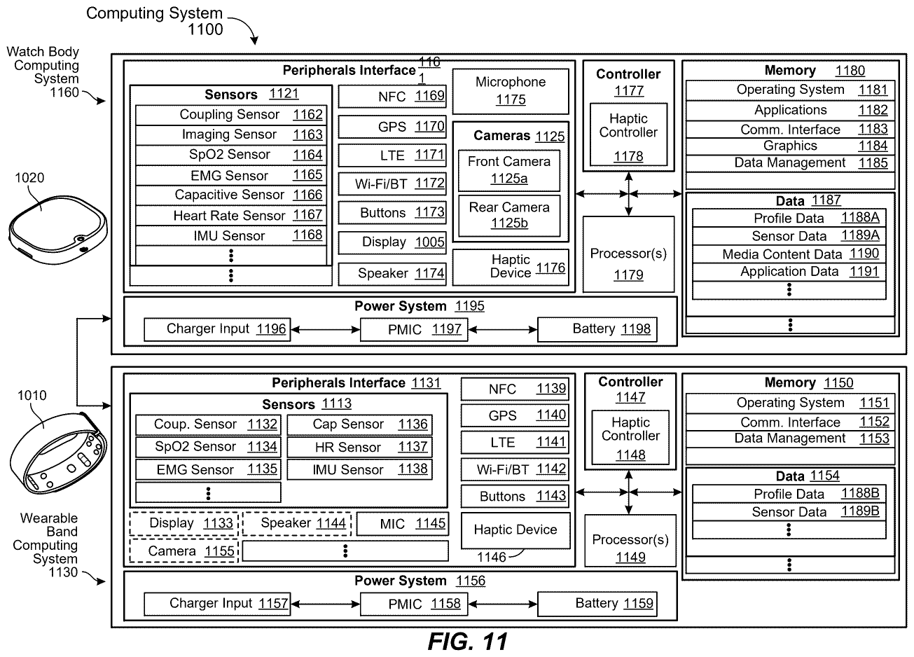

A wrist-wearable device 1000, which can be used for wrist-wearable device 602, 702, 802, 930, and one or more of its components, are described below in reference to FIGS. 10 and 11; head-wearable devices 1200 and 1300, which can respectively be used for AR glasses 604, 704 or VR headset 850, 920, and their one or more components are described below in reference to FIGS. 12-14.

Referring to FIG. 6, wrist-wearable device 602, AR glasses 604, and/or HIPD 606 can communicatively couple via a network 625 (e.g., cellular, near field, Wi-Fi, personal area network, wireless LAN, etc.). Additionally, wrist-wearable device 602, AR glasses 604, and/or HIPD 606 can also communicatively couple with one or more servers 630, computers 640 (e.g., laptops, computers, etc.), mobile devices 650 (e.g., smartphones, tablets, etc.), and/or other electronic devices via network 625 (e.g., cellular, near field, Wi-Fi, personal area network, wireless LAN, etc.).

In FIG. 6, a user 608 is shown wearing wrist-wearable device 602 and AR glasses 604 and having HIPD 606 on their desk. The wrist-wearable device 602, AR glasses 604, and HIPD 606 facilitate user interaction with an AR environment. In particular, as shown by first AR system 600, wrist-wearable device 602, AR glasses 604, and/or HIPD 606 cause presentation of one or more avatars 610, digital representations of contacts 612, and virtual objects 614. As discussed below, user 608 can interact with one or more avatars 610, digital representations of contacts 612, and virtual objects 614 via wrist-wearable device 602, AR glasses 604, and/or HIPD 606.

User 608 can use any of wrist-wearable device 602, AR glasses 604, and/or HIPD 606 to provide user inputs. For example, user 608 can perform one or more hand gestures that are detected by wrist-wearable device 602 (e.g., using one or more EMG sensors and/or IMUs, described below in reference to FIGS. 10 and 11) and/or AR glasses 604 (e.g., using one or more image sensor or camera, described below in reference to FIGS. 12-10) to provide a user input. Alternatively, or additionally, user 608 can provide a user input via one or more touch surfaces of wrist-wearable device 602, AR glasses 604, HIPD 606, and/or voice commands captured by a microphone of wrist-wearable device 602, AR glasses 604, and/or HIPD 606. In some embodiments, wrist-wearable device 602, AR glasses 604, and/or HIPD 606 include a digital assistant to help user 608 in providing a user input (e.g., completing a sequence of operations, suggesting different operations or commands, providing reminders, confirming a command, etc.). In some embodiments, user 608 can provide a user input via one or more facial gestures and/or facial expressions. For example, cameras of wrist-wearable device 602, AR glasses 604, and/or HIPD 606 can track eyes of user 608 for navigating a user interface.

Wrist-wearable device 602, AR glasses 604, and/or HIPD 606 can operate alone or in conjunction to allow user 608 to interact with the AR environment. In some embodiments, HIPD 606 is configured to operate as a central hub or control center for the wrist-wearable device 602, AR glasses 604, and/or another communicatively coupled device. For example, user 608 can provide an input to interact with the AR environment at any of wrist-wearable device 602, AR glasses 604, and/or HIPD 606, and HIPD 606 can identify one or more back-end and front-end tasks to cause the performance of the requested interaction and distribute instructions to cause the performance of the one or more back-end and front-end tasks at wrist-wearable device 602, AR glasses 604, and/or HIPD 606. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below in reference to FIGS. Error! Reference source not found.-Error! Reference source not found., HIPD 606 can perform the back-end tasks and provide wrist-wearable device 602 and/or AR glasses 604 operational data corresponding to the performed back-end tasks such that wrist-wearable device 602 and/or AR glasses 604 can perform the front-end tasks. In this way, HIPD 606, which has more computational resources and greater thermal headroom than wrist-wearable device 602 and/or AR glasses 604, performs computationally intensive tasks and reduces the computer resource utilization and/or power usage of wrist-wearable device 602 and/or AR glasses 604.

In the example shown by first AR system 600, HIPD 606 identifies one or more back-end tasks and front-end tasks associated with a user request to initiate an AR video call with one or more other users (represented by avatar 610 and the digital representation of contact 612) and distributes instructions to cause the performance of the one or more back-end tasks and front-end tasks. In particular, HIPD 606 performs back-end tasks for processing and/or rendering image data (and other data) associated with the AR video call and provides operational data associated with the performed back-end tasks to AR glasses 604 such that the AR glasses 604 perform front-end tasks for presenting the AR video call (e.g., presenting avatar 610 and digital representation of contact 612).

In some embodiments, HIPD 606 can operate as a focal or anchor point for causing the presentation of information. This allows user 608 to be generally aware of where information is presented. For example, as shown in first AR system 600, avatar 610 and the digital representation of contact 612 are presented above HIPD 606. In particular, HIPD 606 and AR glasses 604 operate in conjunction to determine a location for presenting avatar 610 and the digital representation of contact 612. In some embodiments, information can be presented a predetermined distance from HIPD 606 (e.g., within 5 meters). For example, as shown in first AR system 600, virtual object 614 is presented on the desk some distance from HIPD 606. Similar to the above example, HIPD 606 and AR glasses 604 can operate in conjunction to determine a location for presenting virtual object 614. Alternatively, in some embodiments, presentation of information is not bound by HIPD 606. More specifically, avatar 610, digital representation of contact 612, and virtual object 614 do not have to be presented within a predetermined distance of HIPD 606.

User inputs provided at wrist-wearable device 602, AR glasses 604, and/or HIPD 606 are coordinated such that the user can use any device to initiate, continue, and/or complete an operation. For example, user 608 can provide a user input to AR glasses 604 to cause AR glasses 604 to present virtual object 614 and, while virtual object 614 is presented by AR glasses 604, user 608 can provide one or more hand gestures via wrist-wearable device 602 to interact and/or manipulate virtual object 614.

FIG. 7 shows a user 708 wearing a wrist-wearable device 702 and AR glasses 704, and holding an HIPD 706. In second AR system 700, the wrist-wearable device 702, AR glasses 704, and/or HIPD 706 are used to receive and/or provide one or more messages to a contact of user 708. In particular, wrist-wearable device 702, AR glasses 704, and/or HIPD 706 detect and coordinate one or more user inputs to initiate a messaging application and prepare a response to a received message via the messaging application.

In some embodiments, user 708 initiates, via a user input, an application on wrist-wearable device 702, AR glasses 704, and/or HIPD 706 that causes the application to initiate on at least one device. For example, in second AR system 700, user 708 performs a hand gesture associated with a command for initiating a messaging application (represented by messaging user interface 716), wrist-wearable device 702 detects the hand gesture and, based on a determination that user 708 is wearing AR glasses 704, causes AR glasses 704 to present a messaging user interface 716 of the messaging application. AR glasses 704 can present messaging user interface 716 to user 708 via its display (e.g., as shown by a field of view 718 of user 708). In some embodiments, the application is initiated and executed on the device (e.g., wrist-wearable device 702, AR glasses 704, and/or HIPD 706) that detects the user input to initiate the application, and the device provides another device operational data to cause the presentation of the messaging application. For example, wrist-wearable device 702 can detect the user input to initiate a messaging application, initiate and run the messaging application, and provide operational data to AR glasses 704 and/or HIPD 706 to cause presentation of the messaging application. Alternatively, the application can be initiated and executed at a device other than the device that detected the user input. For example, wrist-wearable device 702 can detect the hand gesture associated with initiating the messaging application and cause HIPD 706 to run the messaging application and coordinate the presentation of the messaging application.

Further, user 708 can provide a user input provided at wrist-wearable device 702, AR glasses 704, and/or HIPD 706 to continue and/or complete an operation initiated at another device. For example, after initiating the messaging application via wrist-wearable device 702 and while AR glasses 704 present messaging user interface 716, user 708 can provide an input at HIPD 706 to prepare a response (e.g., shown by the swipe gesture performed on HIPD 706). Gestures performed by user 708 on HIPD 706 can be provided and/or displayed on another device. For example, a swipe gestured performed on HIPD 706 is displayed on a virtual keyboard of messaging user interface 716 displayed by AR glasses 704.

In some embodiments, wrist-wearable device 702, AR glasses 704, HIPD 706, and/or any other communicatively coupled device can present one or more notifications to user 708. The notification can be an indication of a new message, an incoming call, an application update, a status update, etc. User 708 can select the notification via wrist-wearable device 702, AR glasses 704, and/or HIPD 706 and can cause presentation of an application or operation associated with the notification on at least one device. For example, user 708 can receive a notification that a message was received at wrist-wearable device 702, AR glasses 704, HIPD 706, and/or any other communicatively coupled device and can then provide a user input at wrist-wearable device 702, AR glasses 704, and/or HIPD 706 to review the notification, and the device detecting the user input can cause an application associated with the notification to be initiated and/or presented at wrist-wearable device 702, AR glasses 704, and/or HIPD 706.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 704 can present to user 708 game application data, and HIPD 706 can be used as a controller to provide inputs to the game. Similarly, user 708 can use wrist-wearable device 702 to initiate a camera of AR glasses 704, and user 708 can use wrist-wearable device 702, AR glasses 704, and/or HIPD 706 to manipulate the image capture (e.g., zoom in or out, apply filters, etc.) and capture image data.

Users may interact with the devices disclosed herein in a variety of ways. For example, as shown in FIGS. 8A and 8B, a user 808 may interact with an AR system 800 by donning a VR headset 850 while holding HIPD 806 and wearing wrist-wearable device 802. In this example, AR system 800 may enable a user to interact with a game 810 by swiping their arm. One or more of VR headset 850, HIPD 806, and wrist-wearable device 802 may detect this gesture and, in response, may display a sword strike in game 810. Similarly, in FIGS. 9A and 9B, a user 908 may interact with an AR system 900 by donning a VR headset 920 while wearing haptic device 960 and wrist-wearable device 930. In this example, AR system 900 may enable a user to interact with a game 910 by swiping their arm. One or more of VR headset 920, haptic device 960, and wrist-wearable device 930 may detect this gesture and, in response, may display a spell being cast in game 810.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 1202.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 10 and 11 illustrate an example wrist-wearable device 1000 and an example computer system 1100, in accordance with some embodiments. Wrist-wearable device 1000 is an instance of wearable device 602 described in FIG. 6 herein, such that the wearable device 602 should be understood to have the features of the wrist-wearable device 1000 and vice versa. FIG. 11 illustrates components of the wrist-wearable device 1000, which can be used individually or in combination, including combinations that include other electronic devices and/or electronic components.

FIG. 10 shows a wearable band 1010 and a watch body 1020 (or capsule) being coupled, as discussed below, to form wrist-wearable device 1000. Wrist-wearable device 1000 can perform various functions and/or operations associated with navigating through user interfaces and selectively opening applications as well as the functions and/or operations described above with reference to FIGS. 6-9B.

As will be described in more detail below, operations executed by wrist-wearable device 1000 can include (i) presenting content to a user (e.g., displaying visual content via a display 1005), (ii) detecting (e.g., sensing) user input (e.g., sensing a touch on peripheral button 1023 and/or at a touch screen of the display 1005, a hand gesture detected by sensors (e.g., biopotential sensors)), (iii) sensing biometric data (e.g., neuromuscular signals, heart rate, temperature, sleep, etc.) via one or more sensors 1013, messaging (e.g., text, speech, video, etc.); image capture via one or more imaging devices or cameras 1025, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 1020, independently in wearable band 1010, and/or via an electronic communication between watch body 1020 and wearable band 1010. In some embodiments, functions can be executed on wrist-wearable device 1000 while an AR environment is being presented (e.g., via one of AR systems 600 to 900). The wearable devices described herein can also be used with other types of AR environments.

Wearable band 1010 can be configured to be worn by a user such that an inner surface of a wearable structure 1011 of wearable band 1010 is in contact with the user's skin. In this example, when worn by a user, sensors 1013 may contact the user's skin. In some examples, one or more of sensors 1013 can sense biometric data such as a user's heart rate, a saturated oxygen level, temperature, sweat level, neuromuscular signals, or a combination thereof. One or more of sensors 1013 can also sense data about a user's environment including a user's motion, altitude, location, orientation, gait, acceleration, position, or a combination thereof. In some embodiment, one or more of sensors 1013 can be configured to track a position and/or motion of wearable band 1010. One or more of sensors 1013 can include any of the sensors defined above and/or discussed below with respect to FIG. 10.

One or more of sensors 1013 can be distributed on an inside and/or an outside surface of wearable band 1010. In some embodiments, one or more of sensors 1013 are uniformly spaced along wearable band 1010. Alternatively, in some embodiments, one or more of sensors 1013 are positioned at distinct points along wearable band 1010. As shown in FIG. 10, one or more of sensors 1013 can be the same or distinct. For example, in some embodiments, one or more of sensors 1013 can be shaped as a pill (e.g., sensor 1013a), an oval, a circle a square, an oblong (e.g., sensor 1013c) and/or any other shape that maintains contact with the user's skin (e.g., such that neuromuscular signal and/or other biometric data can be accurately measured at the user's skin). In some embodiments, one or more sensors of 1013 are aligned to form pairs of sensors (e.g., for sensing neuromuscular signals based on differential sensing within each respective sensor). For example, sensor 1013b may be aligned with an adjacent sensor to form sensor pair 1014a and sensor 1013d may be aligned with an adjacent sensor to form sensor pair 1014b. In some embodiments, wearable band 1010 does not have a sensor pair. Alternatively, in some embodiments, wearable band 1010 has a predetermined number of sensor pairs (one pair of sensors, three pairs of sensors, four pairs of sensors, six pairs of sensors, sixteen pairs of sensors, etc.).

Wearable band 1010 can include any suitable number of sensors 1013. In some embodiments, the number and arrangement of sensors 1013 depends on the particular application for which wearable band 1010 is used. For instance, wearable band 1010 can be configured as an armband, wristband, or chest-band that include a plurality of sensors 1013 with different number of sensors 1013, a variety of types of individual sensors with the plurality of sensors 1013, and different arrangements for each use case, such as medical use cases as compared to gaming or general day-to-day use cases.

In accordance with some embodiments, wearable band 1010 further includes an electrical ground electrode and a shielding electrode. The electrical ground and shielding electrodes, like the sensors 1013, can be distributed on the inside surface of the wearable band 1010 such that they contact a portion of the user's skin. For example, the electrical ground and shielding electrodes can be at an inside surface of a coupling mechanism 1016 or an inside surface of a wearable structure 1011. The electrical ground and shielding electrodes can be formed and/or use the same components as sensors 1013. In some embodiments, wearable band 1010 includes more than one electrical ground electrode and more than one shielding electrode.

Sensors 1013 can be formed as part of wearable structure 1011 of wearable band 1010. In some embodiments, sensors 1013 are flush or substantially flush with wearable structure 1011 such that they do not extend beyond the surface of wearable structure 1011. While flush with wearable structure 1011, sensors 1013 are still configured to contact the user's skin (e.g., via a skin-contacting surface). Alternatively, in some embodiments, sensors 1013 extend beyond wearable structure 1011 a predetermined distance (e.g., 0.1-2 mm) to make contact and depress into the user's skin. In some embodiment, sensors 1013 are coupled to an actuator (not shown) configured to adjust an extension height (e.g., a distance from the surface of wearable structure 1011) of sensors 1013 such that sensors 1013 make contact and depress into the user's skin. In some embodiments, the actuators adjust the extension height between 0.01 mm- 1.2 mm. This may allow a the user to customize the positioning of sensors 1013 to improve the overall comfort of the wearable band 1010 when worn while still allowing sensors 1013 to contact the user's skin. In some embodiments, sensors 1013 are indistinguishable from wearable structure 1011 when worn by the user.

Wearable structure 1011 can be formed of an elastic material, elastomers, etc., configured to be stretched and fitted to be worn by the user. In some embodiments, wearable structure 1011 is a textile or woven fabric. As described above, sensors 1013 can be formed as part of a wearable structure 1011. For example, sensors 1013 can be molded into the wearable structure 1011, be integrated into a woven fabric (e.g., sensors 1013 can be sewn into the fabric and mimic the pliability of fabric and can and/or be constructed from a series woven strands of fabric).

Wearable structure 1011 can include flexible electronic connectors that interconnect sensors 1013, the electronic circuitry, and/or other electronic components (described below in reference to FIG. 11) that are enclosed in wearable band 1010. In some embodiments, the flexible electronic connectors are configured to interconnect sensors 1013, the electronic circuitry, and/or other electronic components of wearable band 1010 with respective sensors and/or other electronic components of another electronic device (e.g., watch body 1020). The flexible electronic connectors are configured to move with wearable structure 1011 such that the user adjustment to wearable structure 1011 (e.g., resizing, pulling, folding, etc.) does not stress or strain the electrical coupling of components of wearable band 1010.

As described above, wearable band 1010 is configured to be worn by a user. In particular, wearable band 1010 can be shaped or otherwise manipulated to be worn by a user. For example, wearable band 1010 can be shaped to have a substantially circular shape such that it can be configured to be worn on the user's lower arm or wrist. Alternatively, wearable band 1010 can be shaped to be worn on another body part of the user, such as the user's upper arm (e.g., around a bicep), forearm, chest, legs, etc. Wearable band 1010 can include a retaining mechanism 1012 (e.g., a buckle, a hook and loop fastener, etc.) for securing wearable band 1010 to the user's wrist or other body part. While wearable band 1010 is worn by the user, sensors 1013 sense data (referred to as sensor data) from the user's skin. In some examples, sensors 1013 of wearable band 1010 obtain (e.g., sense and record) neuromuscular signals.

The sensed data (e.g., sensed neuromuscular signals) can be used to detect and/or determine the user's intention to perform certain motor actions. In some examples, sensors 1013 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 1005 of wrist-wearable device 1000 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 1013 can be used to provide a user with an enhanced interaction with a physical object (e.g., devices communicatively coupled with wearable band 1010) and/or a virtual object in an artificial-reality application generated by an artificial-reality system (e.g., user interface objects presented on the display 1005, or another computing device (e.g., a smartphone)).

In some embodiments, wearable band 1010 includes one or more haptic devices 1146 (e.g., a vibratory haptic actuator) that are configured to provide haptic feedback (e.g., a cutaneous and/or kinesthetic sensation, etc.) to the user's skin. Sensors 1013 and/or haptic devices 1146 (shown in FIG. 11) can be configured to operate in conjunction with multiple applications including, without limitation, health monitoring, social media, games, and artificial reality (e.g., the applications associated with artificial reality).

Wearable band 1010 can also include coupling mechanism 1016 for detachably coupling a capsule (e.g., a computing unit) or watch body 1020 (via a coupling surface of the watch body 1020) to wearable band 1010. For example, a cradle or a shape of coupling mechanism 1016 can correspond to shape of watch body 1020 of wrist-wearable device 1000. In particular, coupling mechanism 1016 can be configured to receive a coupling surface proximate to the bottom side of watch body 1020 (e.g., a side opposite to a front side of watch body 1020 where display 1005 is located), such that a user can push watch body 1020 downward into coupling mechanism 1016 to attach watch body 1020 to coupling mechanism 1016. In some embodiments, coupling mechanism 1016 can be configured to receive a top side of the watch body 1020 (e.g., a side proximate to the front side of watch body 1020 where display 1005 is located) that is pushed upward into the cradle, as opposed to being pushed downward into coupling mechanism 1016. In some embodiments, coupling mechanism 1016 is an integrated component of wearable band 1010 such that wearable band 1010 and coupling mechanism 1016 are a single unitary structure. In some embodiments, coupling mechanism 1016 is a type of frame or shell that allows watch body 1020 coupling surface to be retained within or on wearable band 1010 coupling mechanism 1016 (e.g., a cradle, a tracker band, a support base, a clasp, etc.).

Coupling mechanism 1016 can allow for watch body 1020 to be detachably coupled to the wearable band 1010 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1020 to wearable band 1010 and to decouple the watch body 1020 from the wearable band 1010. For example, a user can twist, slide, turn, push, pull, or rotate watch body 1020 relative to wearable band 1010, or a combination thereof, to attach watch body 1020 to wearable band 1010 and to detach watch body 1020 from wearable band 1010. Alternatively, as discussed below, in some embodiments, the watch body 1020 can be decoupled from the wearable band 1010 by actuation of a release mechanism 1029.

Wearable band 1010 can be coupled with watch body 1020 to increase the functionality of wearable band 1010 (e.g., converting wearable band 1010 into wrist-wearable device 1000, adding an additional computing unit and/or battery to increase computational resources and/or a battery life of wearable band 1010, adding additional sensors to improve sensed data, etc.). As described above, wearable band 1010 and coupling mechanism 1016 are configured to operate independently (e.g., execute functions independently) from watch body 1020. For example, coupling mechanism 1016 can include one or more sensors 1013 that contact a user's skin when wearable band 1010 is worn by the user, with or without watch body 1020 and can provide sensor data for determining control commands.

A user can detach watch body 1020 from wearable band 1010 to reduce the encumbrance of wrist-wearable device 1000 to the user. For embodiments in which watch body 1020 is removable, watch body 1020 can be referred to as a removable structure, such that in these embodiments wrist-wearable device 1000 includes a wearable portion (e.g., wearable band 1010) and a removable structure (e.g., watch body 1020).

Turning to watch body 1020, in some examples watch body 1020 can have a substantially rectangular or circular shape. Watch body 1020 is configured to be worn by the user on their wrist or on another body part. More specifically, watch body 1020 is sized to be easily carried by the user, attached on a portion of the user's clothing, and/or coupled to wearable band 1010 (forming the wrist-wearable device 1000). As described above, watch body 1020 can have a shape corresponding to coupling mechanism 1016 of wearable band 1010. In some embodiments, watch body 1020 includes a single release mechanism 1029 or multiple release mechanisms (e.g., two release mechanisms 1029 positioned on opposing sides of watch body 1020, such as spring-loaded buttons) for decoupling watch body 1020 from wearable band 1010. Release mechanism 1029 can include, without limitation, a button, a knob, a plunger, a handle, a lever, a fastener, a clasp, a dial, a latch, or a combination thereof.

A user can actuate release mechanism 1029 by pushing, turning, lifting, depressing, shifting, or performing other actions on release mechanism 1029. Actuation of release mechanism 1029 can release (e.g., decouple) watch body 1020 from coupling mechanism 1016 of wearable band 1010, allowing the user to use watch body 1020 independently from wearable band 1010 and vice versa. For example, decoupling watch body 1020 from wearable band 1010 can allow a user to capture images using rear-facing camera 1025b. Although release mechanism 1029 is shown positioned at a corner of watch body 1020, release mechanism 1029 can be positioned anywhere on watch body 1020 that is convenient for the user to actuate. In addition, in some embodiments, wearable band 1010 can also include a respective release mechanism for decoupling watch body 1020 from coupling mechanism 1016. In some embodiments, release mechanism 1029 is optional and watch body 1020 can be decoupled from coupling mechanism 1016 as described above (e.g., via twisting, rotating, etc.).

Watch body 1020 can include one or more peripheral buttons 1023 and 1027 for performing various operations at watch body 1020. For example, peripheral buttons 1023 and 1027 can be used to turn on or wake (e.g., transition from a sleep state to an active state) display 1005, unlock watch body 1020, increase or decrease a volume, increase or decrease a brightness, interact with one or more applications, interact with one or more user interfaces, etc. Additionally or alternatively, in some embodiments, display 1005 operates as a touch screen and allows the user to provide one or more inputs for interacting with watch body 1020.

In some embodiments, watch body 1020 includes one or more sensors 1021. Sensors 1021 of watch body 1020 can be the same or distinct from sensors 1013 of wearable band 1010. Sensors 1021 of watch body 1020 can be distributed on an inside and/or an outside surface of watch body 1020. In some embodiments, sensors 1021 are configured to contact a user's skin when watch body 1020 is worn by the user. For example, sensors 1021 can be placed on the bottom side of watch body 1020 and coupling mechanism 1016 can be a cradle with an opening that allows the bottom side of watch body 1020 to directly contact the user's skin. Alternatively, in some embodiments, watch body 1020 does not include sensors that are configured to contact the user's skin (e.g., including sensors internal and/or external to the watch body 1020 that are configured to sense data of watch body 1020 and the surrounding environment). In some embodiments, sensors 1021 are configured to track a position and/or motion of watch body 1020.

Watch body 1020 and wearable band 1010 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 1020 and wearable band 1010 can share data sensed by sensors 1013 and 1021, as well as application and device specific information (e.g., active and/or available applications, output devices (e.g., displays, speakers, etc.), input devices (e.g., touch screens, microphones, imaging sensors, etc.).

In some embodiments, watch body 1020 can include, without limitation, a front-facing camera 1025a and/or a rear-facing camera 1025b, sensors 1021 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1163), a touch sensor, a sweat sensor, etc.). In some embodiments, watch body 1020 can include one or more haptic devices 1176 (e.g., a vibratory haptic actuator) that is configured to provide haptic feedback (e.g., a cutaneous and/or kinesthetic sensation, etc.) to the user. Sensors 1121 and/or haptic device 1176 can also be configured to operate in conjunction with multiple applications including, without limitation, health monitoring applications, social media applications, game applications, and artificial reality applications (e.g., the applications associated with artificial reality).

As described above, watch body 1020 and wearable band 1010, when coupled, can form wrist-wearable device 1000. When coupled, watch body 1020 and wearable band 1010 may operate as a single device to execute functions (operations, detections, communications, etc.) described herein. In some embodiments, each device may be provided with particular instructions for performing the one or more operations of wrist-wearable device 1000. For example, in accordance with a determination that watch body 1020 does not include neuromuscular signal sensors, wearable band 1010 can include alternative instructions for performing associated instructions (e.g., providing sensed neuromuscular signal data to watch body 1020 via a different electronic device). Operations of wrist-wearable device 1000 can be performed by watch body 1020 alone or in conjunction with wearable band 1010 (e.g., via respective processors and/or hardware components) and vice versa. In some embodiments, operations of wrist-wearable device 1000, watch body 1020, and/or wearable band 1010 can be performed in conjunction with one or more processors and/or hardware components.

As described below with reference to the block diagram of FIG. 11, wearable band 1010 and/or watch body 1020 can each include independent resources required to independently execute functions. For example, wearable band 1010 and/or watch body 1020 can each include a power source (e.g., a battery), a memory, data storage, a processor (e.g., a central processing unit (CPU)), communications, a light source, and/or input/output devices.

FIG. 11 shows block diagrams of a computing system 1130 corresponding to wearable band 1010 and a computing system 1160 corresponding to watch body 1020 according to some embodiments. Computing system 1100 of wrist-wearable device 1000 may include a combination of components of wearable band computing system 1130 and watch body computing system 1160, in accordance with some embodiments.

Watch body 1020 and/or wearable band 1010 can include one or more components shown in watch body computing system 1160. In some embodiments, a single integrated circuit may include all or a substantial portion of the components of watch body computing system 1160 included in a single integrated circuit. Alternatively, in some embodiments, components of the watch body computing system 1160 may be included in a plurality of integrated circuits that are communicatively coupled. In some embodiments, watch body computing system 1160 may be configured to couple (e.g., via a wired or wireless connection) with wearable band computing system 1130, which may allow the computing systems to share components, distribute tasks, and/or perform other operations described herein (individually or as a single device).

Watch body computing system 1160 can include one or more processors 1179, a controller 1177, a peripherals interface 1161, a power system 1195, and memory (e.g., a memory 1180).

Power system 1195 can include a charger input 1196, a power-management integrated circuit (PMIC) 1197, and a battery 1198. In some embodiments, a watch body 1020 and a wearable band 1010 can have respective batteries (e.g., battery 1198 and 1159) and can share power with each other. Watch body 1020 and wearable band 1010 can receive a charge using a variety of techniques. In some embodiments, watch body 1020 and wearable band 1010 can use a wired charging assembly (e.g., power cords) to receive the charge. Alternatively, or in addition, watch body 1020 and/or wearable band 1010 can be configured for wireless charging. For example, a portable charging device can be designed to mate with a portion of watch body 1020 and/or wearable band 1010 and wirelessly deliver usable power to battery 1198 of watch body 1020 and/or battery 1159 of wearable band 1010. Watch body 1020 and wearable band 1010 can have independent power systems (e.g., power system 1195 and 1156, respectively) to enable each to operate independently. Watch body 1020 and wearable band 1010 can also share power (e.g., one can charge the other) via respective PMICs (e.g., PMICs 1197 and 1158) and charger inputs (e.g., 1157 and 1196) that can share power over power and ground conductors and/or over wireless charging antennas.

In some embodiments, peripherals interface 1161 can include one or more sensors 1121. Sensors 1121 can include one or more coupling sensors 1162 for detecting when watch body 1020 is coupled with another electronic device (e.g., a wearable band 1010). Sensors 1121 can include one or more imaging sensors 1163 (e.g., one or more of cameras 1125, and/or separate imaging sensors 1163 (e.g., thermal-imaging sensors)). In some embodiments, sensors 1121 can include one or more SpO2 sensors 1164. In some embodiments, sensors 1121 can include one or more biopotential-signal sensors (e.g., EMG sensors 1165, which may be disposed on an interior, user-facing portion of watch body 1020 and/or wearable band 1010). In some embodiments, sensors 1121 may include one or more capacitive sensors 1166. In some embodiments, sensors 1121 may include one or more heart rate sensors 1167. In some embodiments, sensors 1121 may include one or more IMU sensors 1168. In some embodiments, one or more IMU sensors 1168 can be configured to detect movement of a user's hand or other location where watch body 1020 is placed or held.

In some embodiments, one or more of sensors 1121 may provide an example human-machine interface. For example, a set of neuromuscular sensors, such as EMG sensors 1165, may be arranged circumferentially around wearable band 1010 with an interior surface of EMG sensors 1165 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 1010 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 1179. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 1165 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 1161 includes a near-field communication (NFC) component 1169, a global-position system (GPS) component 1170, a long-term evolution (LTE) component 1171, and/or a Wi-Fi and/or Bluetooth communication component 1172. In some embodiments, peripherals interface 1161 includes one or more buttons 1173 (e.g., peripheral buttons 1023 and 1027 in FIG. 10), which, when selected by a user, cause operation to be performed at watch body 1020. In some embodiments, the peripherals interface 1161 includes one or more indicators, such as a light emitting diode (LED), to provide a user with visual indicators (e.g., message received, low battery, active microphone and/or camera, etc.).

Watch body 1020 can include at least one display 1005 for displaying visual representations of information or data to a user, including user-interface elements and/or three-dimensional virtual objects. The display can also include a touch screen for inputting user inputs, such as touch gestures, swipe gestures, and the like. Watch body 1020 can include at least one speaker 1174 and at least one microphone 1175 for providing audio signals to the user and receiving audio input from the user. The user can provide user inputs through microphone 1175 and can also receive audio output from speaker 1174 as part of a haptic event provided by haptic controller 1178. Watch body 1020 can include at least one camera 1125, including a front camera 1125a and a rear camera 1125b. Cameras 1125 can include ultra-wide-angle cameras, wide angle cameras, fish-eye cameras, spherical cameras, telephoto cameras, depth-sensing cameras, or other types of cameras.

Watch body computing system 1160 can include one or more haptic controllers 1178 and associated componentry (e.g., haptic devices 1176) for providing haptic events at watch body 1020 (e.g., a vibrating sensation or audio output in response to an event at the watch body 1020). Haptic controllers 1178 can communicate with one or more haptic devices 1176, such as electroacoustic devices, including a speaker of the one or more speakers 1174 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 1178 can provide haptic events to that are capable of being sensed by a user of watch body 1020. In some embodiments, one or more haptic controllers 1178 can receive input signals from an application of applications 1182.

In some embodiments, wearable band computing system 1130 and/or watch body computing system 1160 can include memory 1180, which can be controlled by one or more memory controllers of controllers 1177. In some embodiments, software components stored in memory 1180 include one or more applications 1182 configured to perform operations at the watch body 1020. In some embodiments, one or more applications 1182 may include games, word processors, messaging applications, calling applications, web browsers, social media applications, media streaming applications, financial applications, calendars, clocks, etc. In some embodiments, software components stored in memory 1180 include one or more communication interface modules 1183 as defined above. In some embodiments, software components stored in memory 1180 include one or more graphics modules 1184 for rendering, encoding, and/or decoding audio and/or visual data and one or more data management modules 1185 for collecting, organizing, and/or providing access to data 1187 stored in memory 1180. In some embodiments, one or more of applications 1182 and/or one or more modules can work in conjunction with one another to perform various tasks at the watch body 1020.

In some embodiments, software components stored in memory 1180 can include one or more operating systems 1181 (e.g., a Linux-based operating system, an Android operating system, etc.). Memory 1180 can also include data 1187. Data 1187 can include profile data 1188A, sensor data 1189A, media content data 1190, and application data 1191.

It should be appreciated that watch body computing system 1160 is an example of a computing system within watch body 1020, and that watch body 1020 can have more or fewer components than shown in watch body computing system 1160, can combine two or more components, and/or can have a different configuration and/or arrangement of the components. The various components shown in watch body computing system 1160 are implemented in hardware, software, firmware, or a combination thereof, including one or more signal processing and/or application-specific integrated circuits.

Turning to the wearable band computing system 1130, one or more components that can be included in wearable band 1010 are shown. Wearable band computing system 1130 can include more or fewer components than shown in watch body computing system 1160, can combine two or more components, and/or can have a different configuration and/or arrangement of some or all of the components. In some embodiments, all, or a substantial portion of the components of wearable band computing system 1130 are included in a single integrated circuit. Alternatively, in some embodiments, components of wearable band computing system 1130 are included in a plurality of integrated circuits that are communicatively coupled. As described above, in some embodiments, wearable band computing system 1130 is configured to couple (e.g., via a wired or wireless connection) with watch body computing system 1160, which allows the computing systems to share components, distribute tasks, and/or perform other operations described herein (individually or as a single device).

Wearable band computing system 1130, similar to watch body computing system 1160, can include one or more processors 1149, one or more controllers 1147 (including one or more haptics controllers 1148), a peripherals interface 1131 that can includes one or more sensors 1113 and other peripheral devices, a power source (e.g., a power system 1156), and memory (e.g., a memory 1150) that includes an operating system (e.g., an operating system 1151), data (e.g., data 1154 including profile data 1188B, sensor data 1189B, etc.), and one or more modules (e.g., a communications interface module 1152, a data management module 1153, etc.).

One or more of sensors 1113 can be analogous to sensors 1121 of watch body computing system 1160. For example, sensors 1113 can include one or more coupling sensors 1132, one or more SpO2 sensors 1134, one or more EMG sensors 1135, one or more capacitive sensors 1136, one or more heart rate sensors 1137, and one or more IMU sensors 1138.

Peripherals interface 1131 can also include other components analogous to those included in peripherals interface 1161 of watch body computing system 1160, including an NFC component 1139, a GPS component 1140, an LTE component 1141, a Wi-Fi and/or Bluetooth communication component 1142, and/or one or more haptic devices 1146 as described above in reference to peripherals interface 1161. In some embodiments, peripherals interface 1131 includes one or more buttons 1143, a display 1133, a speaker 1144, a microphone 1145, and a camera 1155. In some embodiments, peripherals interface 1131 includes one or more indicators, such as an LED.

It should be appreciated that wearable band computing system 1130 is an example of a computing system within wearable band 1010, and that wearable band 1010 can have more or fewer components than shown in wearable band computing system 1130, combine two or more components, and/or have a different configuration and/or arrangement of the components. The various components shown in wearable band computing system 1130 can be implemented in one or more of a combination of hardware, software, or firmware, including one or more signal processing and/or application-specific integrated circuits.

Wrist-wearable device 1000 with respect to FIG. 10 is an example of wearable band 1010 and watch body 1020 coupled together, so wrist-wearable device 1000 will be understood to include the components shown and described for wearable band computing system 1130 and watch body computing system 1160. In some embodiments, wrist-wearable device 1000 has a split architecture (e.g., a split mechanical architecture, a split electrical architecture, etc.) between watch body 1020 and wearable band 1010. In other words, all of the components shown in wearable band computing system 1130 and watch body computing system 1160 can be housed or otherwise disposed in a combined wrist-wearable device 1000 or within individual components of watch body 1020, wearable band 1010, and/or portions thereof (e.g., a coupling mechanism 1016 of wearable band 1010).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 1000 can be used in conjunction with a head-wearable device (e.g., AR glasses 1200 and VR system 1310) and/or an HIPD Error! Reference source not found.00 described below, and wrist-wearable device 1000 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 1200 and VR headset 1310.

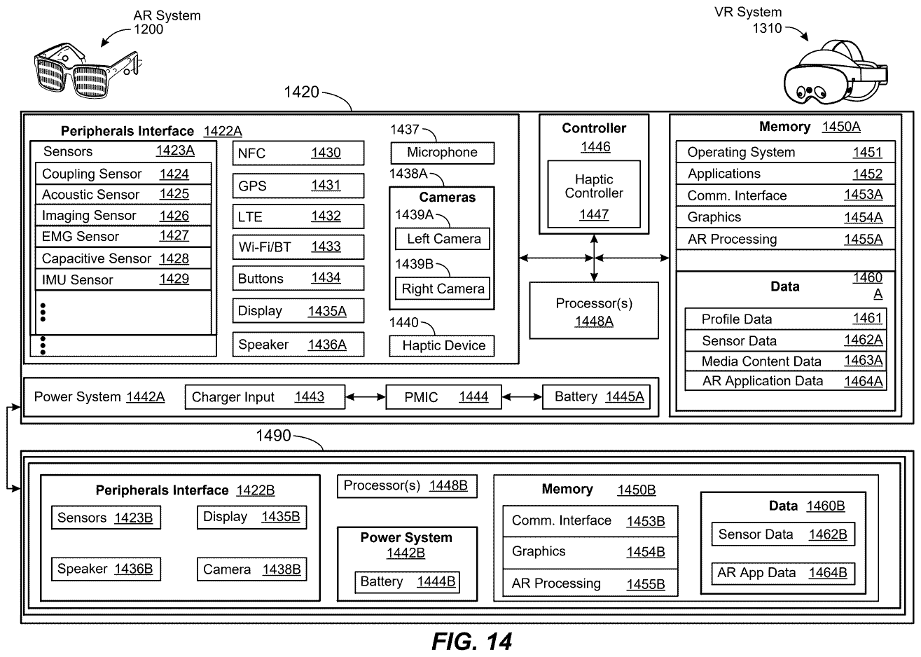

FIGS. 12 to 14 show example artificial-reality systems, which can be used as or in connection with wrist-wearable device 1000. In some embodiments, AR system 1200 includes an eyewear device 1202, as shown in FIG. 12. In some embodiments, VR system 1310 includes a head-mounted display (HMD) 1312, as shown in FIGS. 13A and 13B. In some embodiments, AR system 1200 and VR system 1310 can include one or more analogous components (e.g., components for presenting interactive artificial-reality environments, such as processors, memory, and/or presentation devices, including one or more displays and/or one or more waveguides), some of which are described in more detail with respect to FIG. 14. As described herein, a head-wearable device can include components of eyewear device 1202 and/or head-mounted display 1312. Some embodiments of head-wearable devices do not include any displays, including any of the displays described with respect to AR system 1200 and/or VR system 1310. While the example artificial-reality systems are respectively described herein as AR system 1200 and VR system 1310, either or both of the example AR systems described herein can be configured to present fully-immersive virtual-reality scenes presented in substantially all of a user's field of view or subtler augmented-reality scenes that are presented within a portion, less than all, of the user's field of view.

FIG. 12 show an example visual depiction of AR system 1200, including an eyewear device 1202 (which may also be described herein as augmented-reality glasses, and/or smart glasses). AR system 1200 can include additional electronic components that are not shown in FIG. 12, such as a wearable accessory device and/or an intermediary processing device, in electronic communication or otherwise configured to be used in conjunction with the eyewear device 1202. In some embodiments, the wearable accessory device and/or the intermediary processing device may be configured to couple with eyewear device 1202 via a coupling mechanism in electronic communication with a coupling sensor 1424 (FIG. 14), where coupling sensor 1424 can detect when an electronic device becomes physically or electronically coupled with eyewear device 1202. In some embodiments, eyewear device 1202 can be configured to couple to a housing 1490 (FIG. 14), which may include one or more additional coupling mechanisms configured to couple with additional accessory devices. The components shown in FIG. 12 can be implemented in hardware, software, firmware, or a combination thereof, including one or more signal-processing components and/or application-specific integrated circuits (ASICs).

Eyewear device 1202 includes mechanical glasses components, including a frame 1204 configured to hold one or more lenses (e.g., one or both lenses 1206-1 and 1206-2). One of ordinary skill in the art will appreciate that eyewear device 1202 can include additional mechanical components, such as hinges configured to allow portions of frame 1204 of eyewear device 1202 to be folded and unfolded, a bridge configured to span the gap between lenses 1206-1 and 1206-2 and rest on the user's nose, nose pads configured to rest on the bridge of the nose and provide support for eyewear device 1202, earpieces configured to rest on the user's ears and provide additional support for eyewear device 1202, temple arms configured to extend from the hinges to the earpieces of eyewear device 1202, and the like. One of ordinary skill in the art will further appreciate that some examples of AR system 1200 can include none of the mechanical components described herein. For example, smart contact lenses configured to present artificial reality to users may not include any components of eyewear device 1202.

Eyewear device 1202 includes electronic components, many of which will be described in more detail below with respect to FIG. 14. Some example electronic components are illustrated in FIG. 12, including acoustic sensors 1225-1, 1225-2, 1225-3, 1225-4, 1225-5, and 1225-6, which can be distributed along a substantial portion of the frame 1204 of eyewear device 1202. Eyewear device 1202 also includes a left camera 1239A and a right camera 1239B, which are located on different sides of the frame 1204. Eyewear device 1202 also includes a processor 1248 (or any other suitable type or form of integrated circuit) that is embedded into a portion of the frame 1204.

FIGS. 13A and 13B show a VR system 1310 that includes a head-mounted display (HMD) 1312 (e.g., also referred to herein as an artificial-reality headset, a head-wearable device, a VR headset, etc.), in accordance with some embodiments. As noted, some artificial-reality systems (e.g., AR system 1200) may, instead of blending an artificial reality with actual reality, substantially replace one or more of a user's visual and/or other sensory perceptions of the real world with a virtual experience (e.g., AR systems 800 and 900).

HMD 1312 includes a front body 1314 and a frame 1316 (e.g., a strap or band) shaped to fit around a user's head. In some embodiments, front body 1314 and/or frame 1316 include one or more electronic elements for facilitating presentation of and/or interactions with an AR and/or VR system (e.g., displays, IMUs, tracking emitter or detectors). In some embodiments, HMD 1312 includes output audio transducers (e.g., an audio transducer 1318), as shown in FIG. 13B. In some embodiments, one or more components, such as the output audio transducer(s) 1318 and frame 1316, can be configured to attach and detach (e.g., are detachably attachable) to HMD 1312 (e.g., a portion or all of frame 1316, and/or audio transducer 1318), as shown in FIG. 13B. In some embodiments, coupling a detachable component to HMD 1312 causes the detachable component to come into electronic communication with HMD 1312.

FIGS. 13A and 13B also show that VR system 1310 includes one or more cameras, such as left camera 1339A and right camera 1339B, which can be analogous to left and right cameras 1239A and 1239B on frame 1204 of eyewear device 1202. In some embodiments, VR system 1310 includes one or more additional cameras (e.g., cameras 1339C and 1339D), which can be configured to augment image data obtained by left and right cameras 1339A and 1339B by providing more information. For example, camera 1339C can be used to supply color information that is not discerned by cameras 1339A and 1339B. In some embodiments, one or more of cameras 1339A to 1339D can include an optional IR cut filter configured to remove IR light from being received at the respective camera sensors.

FIG. 14 illustrates a computing system 1420 and an optional housing 1490, each of which show components that can be included in AR system 1200 and/or VR system 1310. In some embodiments, more or fewer components can be included in optional housing 1490 depending on practical restraints of the respective AR system being described.

In some embodiments, computing system 1420 can include one or more peripherals interfaces 1422A and/or optional housing 1490 can include one or more peripherals interfaces 1422B. Each of computing system 1420 and optional housing 1490 can also include one or more power systems 1442A and 1442B, one or more controllers 1446 (including one or more haptic controllers 1447), one or more processors 1448A and 1448B (as defined above, including any of the examples provided), and memory 1450A and 1450B, which can all be in electronic communication with each other. For example, the one or more processors 1448A and 1448B can be configured to execute instructions stored in memory 1450A and 1450B, which can cause a controller of one or more of controllers 1446 to cause operations to be performed at one or more peripheral devices connected to peripherals interface 1422A and/or 1422B. In some embodiments, each operation described can be powered by electrical power provided by power system 1442A and/or 1442B.

In some embodiments, peripherals interface 1422A can include one or more devices configured to be part of computing system 1420, some of which have been defined above and/or described with respect to the wrist-wearable devices shown in FIGS. 10 and 11. For example, peripherals interface 1422A can include one or more sensors 1423A. Some example sensors 1423A include one or more coupling sensors 1424, one or more acoustic sensors 1425, one or more imaging sensors 1426, one or more EMG sensors 1427, one or more capacitive sensors 1428, one or more IMU sensors 1429, and/or any other types of sensors explained above or described with respect to any other embodiments discussed herein.

In some embodiments, peripherals interfaces 1422A and 1422B can include one or more additional peripheral devices, including one or more NFC devices 1430, one or more GPS devices 1431, one or more LTE devices 1432, one or more Wi-Fi and/or Bluetooth devices 1433, one or more buttons 1434 (e.g., including buttons that are slidable or otherwise adjustable), one or more displays 1435A and 1435B, one or more speakers 1436A and 1436B, one or more microphones 1437, one or more cameras 1438A and 1438B (e.g., including the left camera 1439A and/or a right camera 1439B), one or more haptic devices 1440, and/or any other types of peripheral devices defined above or described with respect to any other embodiments discussed herein.

AR systems can include a variety of types of visual feedback mechanisms (e.g., presentation devices). For example, display devices in AR system 1200 and/or VR system 1310 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 1435A and 1435B can be coupled to each of the lenses 1206-1 and 1206-2 of AR system 1200. Displays 1435A and 1435B may be coupled to each of lenses 1206-1 and 1206-2, which can act together or independently to present an image or series of images to a user. In some embodiments, AR system 1200 includes a single display 1435A or 1435B (e.g., a near-eye display) or more than two displays 1435A and 1435B. In some embodiments, a first set of one or more displays 1435A and 1435B can be used to present an augmented-reality environment, and a second set of one or more display devices 1435A and 1435B can be used to present a virtual-reality environment. In some embodiments, one or more waveguides are used in conjunction with presenting artificial-reality content to the user of AR system 1200 (e.g., as a means of delivering light from one or more displays 1435A and 1435B to the user's eyes). In some embodiments, one or more waveguides are fully or partially integrated into the eyewear device 1202. Additionally, or alternatively to display screens, some artificial-reality systems include one or more projection systems. For example, display devices in AR system 1200 and/or VR system 1310 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 1435A and 1435B.

Computing system 1420 and/or optional housing 1490 of AR system 1200 or VR system 1310 can include some or all of the components of a power system 1442A and 1442B. Power systems 1442A and 1442B can include one or more charger inputs 1443, one or more PMICs 1444, and/or one or more batteries 1445A and 1444B.

Memory 1450A and 1450B may include instructions and data, some or all of which may be stored as non-transitory computer-readable storage media within the memories 1450A and 1450B. For example, memory 1450A and 1450B can include one or more operating systems 1451, one or more applications 1452, one or more communication interface applications 1453A and 1453B, one or more graphics applications 1454A and 1454B, one or more AR processing applications 1455A and 1455B, and/or any other types of data defined above or described with respect to any other embodiments discussed herein.

Memory 1450A and 1450B also include data 1460A and 1460B, which can be used in conjunction with one or more of the applications discussed above. Data 1460A and 1460B can include profile data 1461, sensor data 1462A and 1462B, media content data 1463A, AR application data 1464A and 1464B, and/or any other types of data defined above or described with respect to any other embodiments discussed herein.

In some embodiments, controller 1446 of eyewear device 1202 may process information generated by sensors 1423A and/or 1423B on eyewear device 1202 and/or another electronic device within AR system 1200. For example, controller 1446 can process information from acoustic sensors 1225-1 and 1225-2. For each detected sound, controller 1446 can perform a direction of arrival (DOA) estimation to estimate a direction from which the detected sound arrived at eyewear device 1202 of AR system 1200. As one or more of acoustic sensors 1425 (e.g., the acoustic sensors 1225-1, 1225-2) detects sounds, controller 1446 can populate an audio data set with the information (e.g., represented in FIG. 14 as sensor data 1462A and 1462B).

In some embodiments, a physical electronic connector can convey information between eyewear device 1202 and another electronic device and/or between one or more processors 1248, 1448A, 1448B of AR system 1200 or VR system 1310 and controller 1446. The information can be in the form of optical data, electrical data, wireless data, or any other transmittable data form. Moving the processing of information generated by eyewear device 1202 to an intermediary processing device can reduce weight and heat in the eyewear device, making it more comfortable and safer for a user. In some embodiments, an optional wearable accessory device (e.g., an electronic neckband) is coupled to eyewear device 1202 via one or more connectors. The connectors can be wired or wireless connectors and can include electrical and/or non-electrical (e.g., structural) components. In some embodiments, eyewear device 1202 and the wearable accessory device can operate independently without any wired or wireless connection between them.

In some situations, pairing external devices, such as an intermediary processing device (e.g., HIPD 606, 706, 806) with eyewear device 1202 (e.g., as part of AR system 1200) enables eyewear device 1202 to achieve a similar form factor of a pair of glasses while still providing sufficient battery and computation power for expanded capabilities. Some, or all, of the battery power, computational resources, and/or additional features of AR system 1200 can be provided by a paired device or shared between a paired device and eyewear device 1202, thus reducing the weight, heat profile, and form factor of eyewear device 1202 overall while allowing eyewear device 1202 to retain its desired functionality. For example, the wearable accessory device can allow components that would otherwise be included on eyewear device 1202 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 1202 standing alone. Because weight carried in the wearable accessory device can be less invasive to a user than weight carried in the eyewear device 1202, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 1200 and/or VR system 1310 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 13A and 13B show VR system 1310 having cameras 1339A to 1339D, which can be used to provide depth information for creating a voxel field and a two-dimensional mesh to provide object information to the user to avoid collisions.

In some embodiments, AR system 1200 and/or VR system 1310 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 1200 and/or VR system 1310, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

In some examples, the augmented reality systems described herein may also include a microphone array with a plurality of acoustic transducers. Acoustic transducers may represent transducers that detect air pressure variations induced by sound waves. Each acoustic transducer may be configured to detect sound and convert the detected sound into an electronic format (e.g., an analog or digital format). A microphone array may include, for example, ten acoustic transducers that may be designed to be placed inside a corresponding ear of the user, acoustic transducers that may be positioned at various locations on an HMD frame a watch band, etc.

In some embodiments, one or more of acoustic transducers may be used as output transducers (e.g., speakers). For example, the artificial reality systems described herein may include acoustic transducers that are earbuds or any other suitable type of headphone or speaker.

The configuration of acoustic transducers of a microphone array may vary and may include any suitable number of transducers. In some embodiments, using higher numbers of acoustic transducers may increase the amount of audio information collected and/or the sensitivity and accuracy of the audio information. In contrast, using a lower number of acoustic transducers may decrease the computing power required by an associated controller to process the collected audio information. In addition, the position of each acoustic transducer of the microphone array may vary. For example, the position of an acoustic transducer may include a defined position on the user, a defined coordinate on a frame of an HMD, an orientation associated with each acoustic transducer, or some combination thereof.

Acoustic transducers and may be positioned on different parts of the user's ear, such as behind the pinna, behind the tragus, and/or within the auricle or fossa. Or, there may be additional acoustic transducers on or surrounding the ear in addition to acoustic transducers inside the ear canal. Having an acoustic transducer positioned next to an ear canal of a user may enable the microphone array to collect information on how sounds arrive at the ear canal. By positioning at least two of acoustic transducers on either side of a user's head (e.g., as binaural microphones), an artificial-reality device may simulate binaural hearing and capture a 3D stereo sound field around about a user's head. In some embodiments, acoustic transducers may be connected to artificial reality systems via a wired connection, and in other embodiments acoustic transducers may be connected to artificial-reality systems via a wireless connection (e.g., a BLUETOOTH connection).

Acoustic transducers may be positioned on HMDs frames in a variety of different ways, including along the length of the temples, across the bridge, above or below display devices, or some combination thereof. Acoustic transducers may also be oriented such that the microphone array is able to detect sounds in a wide range of directions surrounding the user wearing the augmented-reality system. In some embodiments, an optimization process may be performed during manufacturing of augmented-reality system to determine relative positioning of each acoustic transducer in the microphone array.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A holographic display apparatus comprising:
an illumination subsystem having one or more emitters and wavelength-selection elements configured to provide a plurality of mutually incoherent spectral components at discrete wavelengths;
a modulation stage positioned to receive light from the illumination subsystem;
display optics arranged to direct modulated light from the modulation stage toward an image plane; and
control circuitry configured to:
select at least two of the discrete wavelengths and to compute modulation patterns for the modulation stage that decorrelate wavelength-dependent speckle fields at an image plane, and
direct the illumination subsystem to illuminate the modulation stage with the selected wavelengths effectively concurrently within an integration interval and to apply the computed modulation patterns such that intensities from the concurrently illuminated, mutually incoherent wavelengths incoherently sum at the image plane in a manner that reduces speckle.

2. The apparatus of claim 1, wherein:
the modulation stage comprises at least two spatial light modulators separated by a non-zero propagation distance; and
the control circuitry is configured to compute respective modulation patterns for each of the spatial light modulators.

3. The apparatus of claim 2, further comprising relay optics including at least one Fourier-plane aperture configured to filter unwanted diffraction orders or DC components while directing modulated light toward the image plane.

4. The apparatus of claim 1, wherein the control circuitry is configured to:
compute per-wavelength amplitude weights; and
to drive the illumination subsystem according to the computed weights to further decorrelate wavelength-dependent speckle fields at the image plane.

5. The apparatus of claim 1, wherein the control circuitry is configured to determine the selected wavelengths based on a perceptual color objective that incorporates long-, medium-, and short-cone eye response functions and a differentiable color-space transformation.

6. The apparatus of claim 1, wherein the control circuitry is configured to map continuous phase values to modulator drive codes using a wavelength-dependent lookup table and to account for phase quantization when applying the computed modulation patterns.

7. The apparatus of claim 1, wherein the control circuitry is configured to compute modulation patterns over a focal stack of planes to generate random-phase holograms that provide substantially uniform eyebox intensity.

8. The apparatus of claim 1, wherein the illumination subsystem comprises a supercontinuum laser source coupled to a tunable wavelength-selection module configured to provide the plurality of mutually incoherent spectral components at the discrete wavelengths.

9. The apparatus of claim 1, wherein:
the one or more emitters and wavelength selection elements of the illumination subsystem comprise a plurality of spatially separated illumination sources; and
the control circuitry is configured to direct the illumination subsystem to illuminate the modulation stage by effectively concurrently activating at least two of the spatially separated illumination sources together with the selected wavelengths.

10. A method of reducing speckle in a holographic display, the method comprising:
emitting, from an illumination subsystem comprising one or more emitters and wavelength-selection elements, a plurality of mutually incoherent spectral components at discrete wavelengths;
selecting at least two of the discrete wavelengths;
computing, for the selected wavelengths, modulation patterns configured to decorrelate wavelength-dependent speckle fields at an image plane;
concurrently illuminating a modulation stage with the selected wavelengths while applying the computed modulation patterns to the modulation stage; and
displaying modulated light from the modulation stage such that intensities produced by the concurrently illuminated, mutually incoherent wavelengths incoherently sum at the image plane to reduce speckle.

11. The method of claim 10, further comprising:
computing per-wavelength amplitude weights; and
illuminating the modulation stage with the selected wavelengths using the computed per-wavelength amplitude weights.

12. The method of claim 11, wherein computing per-wavelength amplitude weights comprises determining source drive settings for individual emitters or spectral bands such that wavelength-dependent speckle fields are further decorrelated at the image plane.

13. The method of claim 10, wherein:
the modulation stage comprises first and second spatial light modulators separated by a non-zero propagation distance, and
computing the modulation patterns comprises computing respective patterns for the first and second modulators.

14. The method of claim 13, further comprising:
relaying light between the modulators and toward the image plane through relay optics that include at least one Fourier-plane aperture; and
filtering unwanted diffraction orders or DC components with the aperture during the displaying.

15. The method of claim 10, wherein concurrently illuminating comprises illuminating at least two of the selected wavelengths at least substantially concurrently or within an integration interval shorter than a retinal integration time.

16. The method of claim 10, further comprising computing spectral weighting based on long-, medium-, and short-cone eye response functions.

17. The method of claim 10, wherein computing the modulation patterns comprises computing over a focal stack of planes to produce random-phase holograms with substantially uniform eyebox intensity.

18. The method of claim 10, wherein applying the computed modulation patterns comprises mapping continuous phase values to modulator drive codes using a wavelength-dependent lookup table and modeling quantization with a straight-through estimator.

19. A method of manufacturing a holographic display apparatus, the method comprising:
providing an illumination subsystem having configured to provide a plurality of mutually incoherent spectral components at discrete wavelengths;
positioning a modulation stage to receive light from the illumination subsystem; arranging display optics to direct modulated light from the modulation stage toward an image plane; and
programming control circuitry to:
select at least two of the discrete wavelengths,
compute modulation patterns for the modulation stage configured to decorrelate wavelength-dependent speckle fields at the image plane, and
direct the illumination subsystem to illuminate the modulation stage with the selected wavelengths effectively concurrently within an integration interval while applying the computed modulation patterns such that intensities from the concurrently illuminated, mutually incoherent wavelengths incoherently sum at the image plane to reduce speckle.

20. The method of claim 19, further comprising:
integrating the holographic display apparatus into a near-eye display system by mounting the illumination subsystem, modulation stage, and display optics within eyewear housing; and
coupling the modulated light into a near-eye waveguide having in-coupling and out-coupling gratings arranged to deliver the modulated light toward an exit pupil sized to provide an eyebox.
